(19) United States
(12) Patent Application Publication
(10) Pub. No.: US 2026/0196121 A1
(43) Pub. Date: Jul. 9, 2026

(54) MULTI-PERSON BABY MONITOR ALARM

(71) Applicants: Benjamin Ford, The Woodlands, TX (US); Kimberly Ford, The Woodlands, TX (US)

(72) Inventors: Benjamin Ford, The Woodlands, TX (US); Kimberly Ford, The Woodlands, TX (US)

(21) Appl. No.: 19/553,801

(22) Filed: Mar. 2, 2026

Related U.S. Application Data
(63) Continuation-in-part of application No. 18/357,824, filed on Jul. 24, 2023, now Pat. No. 12,446,836.
(63) Continuation-in-part of application No. 19/227,450, filed on Jun. 3, 2025.

(51) Int. Cl. G08B 21/02

(52) U.S. Cl. CPC G08B 21/0219; G08B 21/0211; G08B 21/0225; G08B 21/0236

(57) ABSTRACT

Described herein are systems and techniques for improving the way multiple sleeping people decide who should wake up in response to crying baby. A system includes a processor coupled to a first sleep tracker, a second sleep tracker, and a sensor. The first sleep tracker tracks the sleep of a first person and sends sleep data to the processor, while the second sleep tracker tracks the sleep of a second person and sends sleep data to the processor. The sensor monitors a subject and sends a signal when a change with the subject is detected. The processor receives a signal from the sensor and compares the sleep data from the first and second sleep trackers. The processor also determines which of the first person or second person to alert based on the comparison and transmits an alert to one of the first person or the second person.

### CROSS-REFERENCE TO RELATED APPLICATIONS

This application is a continuation-in-part of U.S. patent application Ser. No. 19/227,450, filed Jun. 3, 2025, titled “Multi-Person Baby Monitor Alarm,” which claims the benefit of U.S. patent application Ser. No. 18/357,824, filed July 24, 2023, the entire disclosures of which are incorporated herein by reference.

### STATEMENT REGARDING FEDERALLY SPONSORED RESEARCH OR DEVELOPMENT

Not applicable.

### BACKGROUND OF THE INVENTION

### Field of the Invention

The present disclosure relates generally to baby monitoring systems, and more particularly to systems and methods for intelligently routing alerts among multiple caregivers based on physiological sleep data, audio event detection, and proximity analysis.

### Description of Related Art

Baby monitors have long been used to allow caregivers to remotely observe or listen to an infant. Conventional baby monitors typically transmit audio and/or video from a nursery unit to a parent unit, requiring a caregiver to remain within range and to manually respond upon hearing or seeing an alert. These systems provide no intelligence regarding which caregiver should respond when multiple caregivers are present in the household.

In households with two or more caregivers, the decision of which caregiver should wake to respond to a crying infant is typically resolved through informal verbal agreements or ad hoc negotiation during the night. These approaches frequently result in inequitable distribution of nighttime responsibilities, sleep deprivation concentrated on one caregiver, and interpersonal friction arising from perceived unfairness.

Some existing systems have attempted to address multi-person monitoring by broadcasting alerts to all caregivers simultaneously, leaving the caregivers to coordinate a response among themselves. These approaches fail to account for the dynamic, real-time physiological states of the caregivers and do not optimize for equitable sleep distribution.

Wearable devices such as smartwatches are capable of measuring physiological signals, including heart rate and heart rate variability, which correlate with sleep depth and stage. However, existing systems do not leverage these physiological signals in real-time to dynamically route infant care alerts to the caregiver who is most physiologically ready to respond.

Furthermore, existing baby monitor systems face significant reliability challenges during overnight operation. Mobile operating systems aggressively manage background application execution, frequently terminating or suspending applications that do not maintain recognized activity indicators. Wearable device operating systems impose time-limited background execution sessions. These platform constraints can result in loss of monitoring capability during the critical overnight period when reliable alert delivery is most important.

Alert delivery in existing systems typically relies on a single communication path, such as a push notification. If that single path fails due to network conditions, platform throttling, or application state, the alert is not delivered. The consequences of missed alerts in the context of infant monitoring are particularly significant, as they may result in an infant's needs going unattended for an extended period.

Accordingly, there is a need for systems and methods that intelligently determine which caregiver to alert based on real-time physiological data, that reliably maintain monitoring capability during extended overnight sessions despite aggressive operating system power management, and that deliver alerts through redundant communication paths to ensure that time-critical notifications reach the selected caregiver.

### SUMMARY OF THE INVENTION

The present disclosure provides systems and methods for a multi-person baby monitor alarm that intelligently routes alerts to caregivers based on physiological sleep data, implements robust cry detection using an asymmetric accumulation model, and ensures reliable alert delivery through multi-path redundant communication architectures.

In one aspect, a system for coordinating selective caregiver alerting across a multi-device monitoring network comprises a hub device comprising a processor, a memory, an audio sensor, and a plurality of communication interfaces. The hub device is positioned in proximity to a monitored subject and is configured to detect an event associated with the monitored subject using the audio sensor, transmit event data and caregiver physiological data to a cloud processor to obtain a routing decision, and upon receiving the routing decision, transmit a targeted alert to a device associated with the selected caregiver. The hub device maintains a locally cached copy of caregiver state data and, upon failure of the network connection to the cloud processor, executes a local routing decision using the locally cached data.

In another aspect, a method for determining a caregiver alert priority in a multi-caregiver monitoring system comprises receiving heart rate data from a wearable device associated with a caregiver, computing a heart rate variability metric, normalizing the metric against a baseline value, inverting the normalized score such that deeper sleep produces a lower wakeability score, and using the wakeability score as an input to a routing decision. The method further comprises computing an effective score by combining the wakeability score with a non-linear fairness penalty, a time-decay adjustment, and a deep sleep equity adjustment to promote equitable distribution of nighttime responsibilities.

In another aspect, a method for detecting a sustained audio event comprises continuously sampling audio data, maintaining an accumulation value with an asymmetric response characteristic wherein the value increases at a first rate when audio exceeds a threshold and decreases at a second, slower rate when audio is below the threshold, and determining that a sustained event has occurred when the accumulation value reaches a trigger level. This approach discriminates between transient noise and sustained distress events.

In another aspect, a system for delivering caregiver alerts across parallel communication paths comprises a hub device and a cloud processor configured to transmit alerts through multiple independent delivery paths, including push notifications to smartphones and direct connections to wearable device platforms. Each alert includes a unique identifier for deduplication, and the system implements a timed escalation cascade for progressive alert delivery.

In another aspect, a method for maintaining continuous physiological monitoring during an extended sleep session comprises maintaining background execution on companion devices using multiple concurrent persistence mechanisms, monitoring data freshness and automatically reinitializing health monitoring sessions upon staleness, and persisting monitoring state to non-volatile storage for automatic recovery.

In another aspect, methods for proximity-based alert suppression, safety-gated firmware updates, protocol-agnostic hub coordination, multi-modal proximity detection, adaptive session management, and enhanced reliability mechanisms are provided as described in the detailed description below.

### BRIEF DESCRIPTION OF THE DRAWINGS

In order to describe the manner in which the features and advantages of this disclosure can be obtained, a more particular description is provided with reference to specific implementations thereof which are illustrated in the appended drawings. Understanding that these drawings depict only exemplary implementations of the disclosure and are not therefore to be considered to be limiting of its scope, the principles herein are described and explained with additional specificity and detail through the use of the accompanying drawings in which:

FIG. 1 is a schematic diagram of an example environment in accordance with various aspects of the subject technology.

FIG. 2 is a block diagram illustrating a suitable computing environment for aspects of the subject technology.

FIG. 3 is a flow diagram illustrating a method of alerting a sleeping person according to various aspects of the subject technology.

FIG. 4 is a flow diagram illustrating a method of alerting a sleeping person according to various aspects of the subject technology.

FIG. 5 is a schematic diagram of an example environment in accordance with various aspects of the subject technology.

FIG. 6 is a block diagram illustrating a suitable computing environment for aspects of the subject technology.

FIG. 7 is a block diagram illustrating a suitable computing environment for aspects of the subject technology.

FIG. 8 is a flow diagram illustrating a method of alerting a sleeping person according to various aspects of the subject technology.

FIG. 9 is a flow diagram illustrating a method of alerting a sleeping person according to various aspects of the subject technology.

FIG. 10 is a diagram illustrating a system overview in accordance with an aspect of the invention including hub, phone, watch, and cloud components in accordance with an embodiment of the present disclosure.

FIG. 11 is a block diagram illustrating the hub device hardware and communication interfaces in accordance with an embodiment of the present disclosure.

FIG. 12 is a diagram illustrating Bluetooth Low Energy (“BLE”) provisioning and heartbeat modes of the hub device in accordance with an embodiment of the present disclosure.

FIG. 13 is a block diagram illustrating a hub multi-protocol coordination architecture in accordance with various aspects of the subject technology.

FIG. 14 is a state diagram illustrating a cry session lifecycle state machine in accordance with various aspects of the subject technology.

FIG. 15 is a diagram illustrating an asymmetric accumulation model for sustained audio event detection in accordance with various aspects of the subject technology.

FIG. 16 is a pipeline diagram illustrating the wakeability scoring computation in accordance with an embodiment of the present disclosure.

FIG. 17 is a block diagram illustrating multi-path alert delivery with deduplication in accordance with various aspects of the subject technology.

FIG. 18 is a layered diagram illustrating a multi-layer reliability architecture for continuous overnight monitoring in accordance with various aspects of the subject technology.

FIG. 19 is a flow diagram illustrating a safety-gated firmware update method in accordance with various aspects of the subject technology.

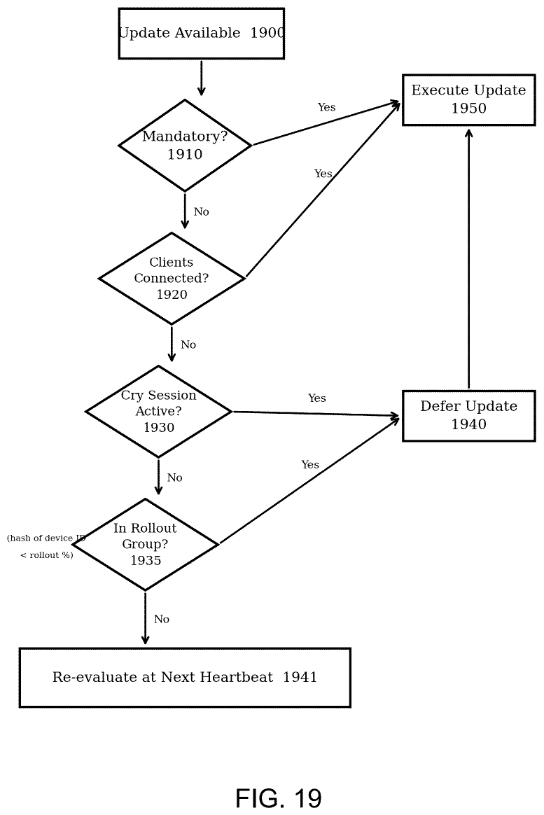

FIG. 20 is a block diagram illustrating a cloud-first routing architecture with local fallback capability in accordance with various aspects of the subject technology.

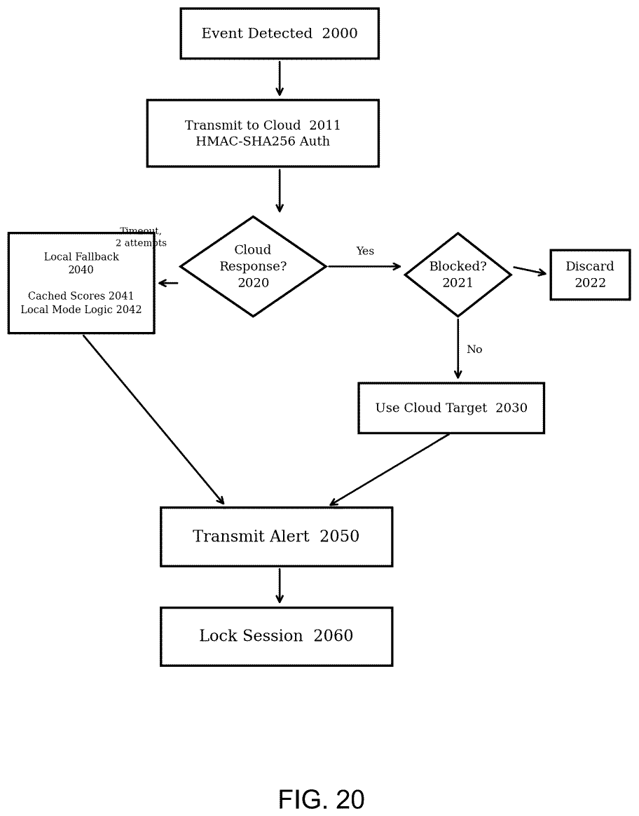

FIG. 21 is a pipeline diagram illustrating the effective score computation combining wakeability score, non-linear fairness penalty, time-decay adjustment, and deep sleep equity adjustment in accordance with an embodiment of the present disclosure.

FIG. 22 is a diagram illustrating BLE proximity detection and alert suppression using received signal strength indicator (“RSSI”) analysis and a log-distance path loss model in accordance with an embodiment of the present disclosure.

FIG. 23 is a state diagram illustrating session mode locking during an active monitoring session, including session lock acquisition, routing mode freeze, and target caregiver assignment persistence in accordance with an embodiment of the present disclosure.

FIG. 24 is a graph illustrating a non-linear fairness penalty function in which penalty magnitude increases at an accelerating rate as alert count increases in accordance with an embodiment of the present disclosure.

FIG. 25 is a graph illustrating a time-decaying recent-wake penalty in which the fairness penalty linearly decays from a maximum value to zero over a defined decay period in accordance with an embodiment of the present disclosure.

FIG. 26 is a pipeline diagram illustrating the adaptive baseline computation for heart rate variability normalization, including population-derived defaults and transition to individual-specific baselines in accordance with an embodiment of the present disclosure.

### DETAILED DESCRIPTION OF THE PREFERRED EMBODIMENTS

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous components. In addition, numerous specific details are set forth in order to provide a thorough understanding of the methods and apparatus described herein. However, it will be understood by those of ordinary skill in the art that the methods and apparatus described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the present disclosure.

### General System Architecture and Methods

The following paragraphs describe the general system architecture, environments, and methods originally disclosed in the parent application, which form the foundation of the present continuation-in-part disclosure. The embodiments described in this section may be combined with or supplemented by the enhanced embodiments described in the subsequent sections of this specification.

This disclosure describes systems, apparatuses, processes (also referred to as methods), and computer-readable media for improving the way parents decide will take care of children at night by only alerting one of the parents and letting the other continue to sleep. The disclosure describes systems and methods that analyze and compare sleeping data to determine which of the persons sleeping is in the best condition to wake up. These methods and systems allow parents to optimize their sleep and still take care of children at night.

The disclosure describes embodiments that compare the sleep of multiple persons sleeping. Sleep data is gathered about each of the multiple persons. The sleep data is then analyzed and at any given moment the data of the multiple persons can be compared in order to determine which person should be alerted. That person is then alerted and the other sleeping person is allowed to remain sleeping.

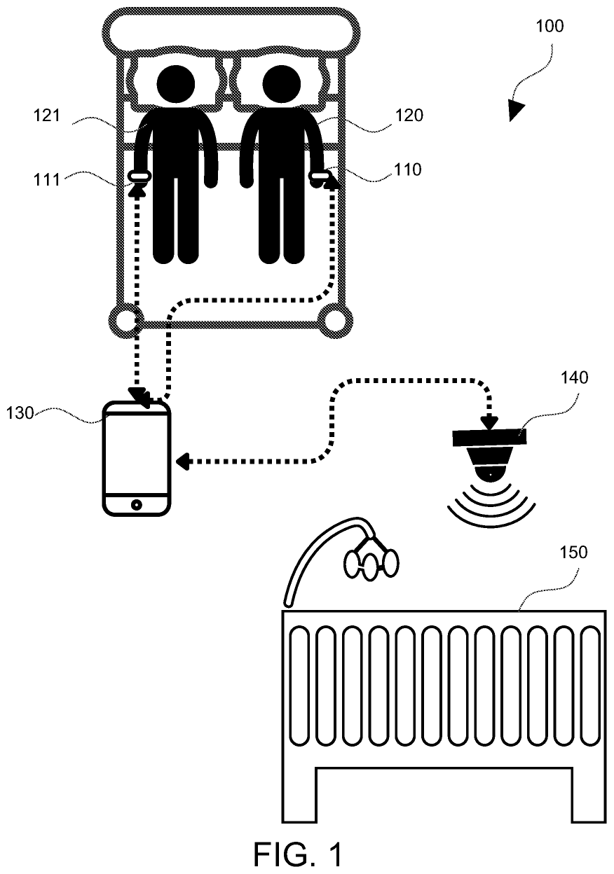

In FIG. 1, a schematic environment 100 of an example embodiment is shown. A first person 120 and a second person 121 of what could be several persons are shown to be asleep. In FIG. 1 the first person 120 has a corresponding sleep tracker 110 and the second person 121 has sleep tracker 111. There are many types of sleep trackers. Some may be worn like a smart watch, smart ring, or bracelet. Others may be positioned adjacent to the person, on or in a bed, attached to the person. Sleep trackers may monitor different metrics including but not limited to heart rate, skin temperature, body movement, blood oxygen levels, brain activity, and body temperature.

As used herein, the term ‘sleep state’ refers broadly to any physiological state during a rest period, encompassing light sleep, deep sleep, rapid eye movement (REM) sleep, wakefulness during a designated rest period, and transitional states between wakefulness and sleep. The sleep state may be characterized by reduced responsiveness to environmental stimuli, altered consciousness, or distinctive physiological patterns including changes in heart rate, heart rate variability, respiratory rate, and body motion, without requiring the monitored subject to achieve a specific sleep stage or quality metric.

As used herein, the term ‘physiological data’ refers to any data derived from biological processes of the monitored subject, including without limitation heart rate, heart rate variability, motion or acceleration, respiratory rate, blood oxygen saturation (SpO2), skin temperature, electrodermal activity or galvanic skin response (GSR), electroencephalography (EEG), and actigraphy data. Physiological data may be measured continuously, periodically, or on-demand, and may be processed in real-time or stored for subsequent analysis.

As used herein, the term ‘caregiver device’ refers to any electronic device associated with a caregiver and capable of receiving, processing, and presenting alerts from the monitoring system. Caregiver devices broadly include smartphones and mobile handsets, wearable devices such as smartwatches or fitness trackers, tablets and portable computers, smart speakers and voice-activated assistants, laptops and desktop computers, and any other computing device with network connectivity and the capacity to deliver notifications to a human user.

FIG. 1 shows a processor 130. The processor 130 may be a mobile phone, virtual voice assistant device, cloud processor, a wearable device, or any other suitable processor. The processor 130 is coupled with sleep trackers 110 and 111, as well as a sensor 140. The sensor 140 in this embodiment is monitoring a subject 150 (e.g., a baby located in a crib) the subject could be a person, an environment, a thing, or anything that a sensor could monitor. The coupling of the processor 130 to the sleep trackers 110 and 111, and the sensor 140 may be over a network such as wifi or the internet, or over a wireless connection type such as Bluetooth®. There may be multiple sensors 140 that are monitoring the same or multiple different subjects 150. The sensors 140 may include any type of sensor (e.g., audio, visual, infrared light emitting devices, non-visible light, thermo, heart rate monitor, blood oxygen, accelerometer, etc. . . . ).

While the first person 120 and the second person 121 are sleeping, the sleep trackers 110 and 111 gather sleep data related to the corresponding person and transmit the data to the processor 130. The data may include or be related to what type of sleep the persons 120 and 121 are in such as Rapid Eye Movement (REM), deep sleep, light sleep, or intermediate sleep. The data may include or be related to how long the persons 120 and 121 have been asleep, it may include or be related to metrics like heart rate, blood oxygen, body movement, brain activity, blood pressure. The sleep data should not be limited to just those that have been listed but may include any information that may help the processor to make a determination about the sleeping condition of persons 120 and 121.

When a change that is detectable by sensor 140 occurs in, around, or with the subject 150, sensor 140 sends a signal to processor 130. Processor 130 then analyzes and compares the sleep data of persons 120 and 121, and makes a determination of which person to alert based on a criteria or combination of criteria.

In order to determine which of the sleeping persons to alert, a criteria for making the determination is selected. Users may choose the criteria or rely on a default criteria. Some example embodiments may use the following criteria, however this list should not be considered exhaustive: amount of time slept, quantity of a specific type of sleep (i.e., Rapid Eye Movement (REM) sleep, deep sleep, intermediate sleep, or light sleep), current phase of a sleep cycle, current type of sleep, amount of a specific combination of the types of sleep, quantity of completed sleep cycles, when a wake up alarm is scheduled, who received the previous alert, who has received the most alerts, what time it is (e.g., alerting one person during one time period and the other in another time period), and percentage of needed sleep time obtained. Needed sleep can be set by each of the persons and may mean the minimum amount of sleep or sleep cycles that a person needs to receive in a night to be well rested. A sleep cycle is understood by those skilled in the art to be an oscillation between the slow-wave and REM (paradoxical) phases of sleep. It is sometimes called the ultradian sleep cycle, sleep-dream cycle, or REM-NREM cycle, to distinguish it from the circadian alternation between sleep and wakefulness. In humans, this cycle takes 70 to 110 minutes (90±20 minutes).

Combinations of criteria may be used in order to prioritize certain criteria above others. For example, the alert may be sent to the person with the most completed sleep cycles, unless that person has received a certain number of alerts more than the other person. Another example may include sending the alert to the person who has an alarm scheduled later, unless the other person is in light sleep and the person is not. These are merely illustrations of how combining criteria may be done and should in no way be understood to be limited by the examples provided.

In certain embodiments, the processor or cloud processor may implement an artificial intelligence (AI) agent to perform the determination of which person to alert. The AI agent can be trained on historical sleep data, user-specific patterns, and multi-variable input data to optimize decision-making in selecting the person to be notified. Such AI systems may utilize supervised or reinforcement learning methods, and may operate using edge AI architectures to reduce latency and protect user data privacy.

For caregiver status, inputs to the AI agent can include, but are not limited to: real-time heart rate variability, body movement via accelerometer data, respiration rate, historical sleep cycle data, current sleep stage approximated from biometric inputs, time since last alert, alarm schedule proximity, ambient noise levels, temperature, light levels, infant crying activity, and subjective sleep targets as manually set by each user or inferred over time. The AI agent may assign a dynamic priority weight to each input and determine the most appropriate person to alert based on a composite score. Caregiver input data may be obtained from wearables having one or more physiological sensors, such as photoplethysmography (PPG) sensors, accelerometers, gyroscopes, and temperature sensors. Biometric data indicative of the subject's condition may include heart rate, blood oxygen saturation, breathing rate, motion or restlessness, temperature, and vocalizations. Environmental data may include ambient temperature, humidity, light intensity, background noise level, CO2 concentration, or recent activity detected near the subject. These inputs may be collected from wearable sensors, cameras, microphones, or environmental sensors integrated into the nursery or sleep environment. Caregiver input data may be obtained from wearables having one or more physiological sensors, such as photoplethysmography (PPG) sensors, accelerometers, gyroscopes, and temperature sensors.

The AI model may be updated periodically with new training data from the user environment to refine prediction accuracy. In some embodiments, the AI processing can occur locally on a processor integrated in the device (e.g., edge device), while in others it may occur on a remote server via secure communication protocols. The AI model may include one or more of: convolutional neural networks (CNNs), recurrent neural networks (RNNs), gradient boosted decision trees (GBDTs), or other machine learning models suited for time-series and classification tasks. The model may also utilize transfer learning from generic sleep or health datasets prior to user-specific fine-tuning. The AI model may output a classification, confidence score, or priority ranking for available caregivers.

Example implementations include using a CNN to classify sleep state from raw accelerometer and heart rate data, followed by a logistic regression model or decision tree classifier to perform the alert decision. This dual-model setup allows for interpretable logic alongside adaptive learning capabilities. Additional logic layers may evaluate recent alert history, time of night, or preference weighting to modulate final outcomes. Alert messages may be formatted for delivery via mobile applications, smart devices, or wearable devices with vibration, audio, or light-based indicators.

In additional embodiments, the AI model may be enhanced with external contextual inputs, such as room temperature, ambient light, environmental noise, or historical infant waking patterns. These factors may be integrated into the decision process to further optimize which user is least impacted by an interruption. In one implementation, environmental inputs are collected through ancillary sensors positioned in the nursery or bedroom. Sensors may include microphones, infrared temperature sensors, photodetectors, smart thermostats, or sound pressure level detectors. These inputs may be digitized and synchronized in time with caregiver metrics to enable correlated analysis.

The alert method may also vary. In addition to haptic feedback, the system may initiate audio alerts (e.g., through a speaker), visual cues (e.g., light pulse or screen notification), or interface with smart home systems (e.g., dimming lights or nudging a connected bed motor) to wake the designated person. In some embodiments, alerts may escalate if not acknowledged within a predefined window. In other cases, alerts may be routed conditionally based on priority tiers, device availability, or sleep quality scores.

Additional embodiments may include the following alternatives to supplement or replace AI or wearable-based implementations:
Non-wearable sensors embedded in or near a bed to detect biometrics such as heart rate, motion, or body temperature. These may include mattress pressure sensors, piezoelectric films, or capacitive pads that detect subtle movements and physiological signals associated with sleep phases. The sensors may be coupled to a processor configured to interpret signal trends and compute user restfulness. The system may estimate motion level, breathing periodicity, and position shifts.

AI-less decision logic based solely on user-input preferences, recent sleep duration estimates, or fixed schedules. User-input preferences may include selections such as a designated primary responder, alternating responsibility schedules (e.g., odd/even days), specific time-based alert availability (e.g., one user prefers not to be alerted between midnight and 3 AM), manual override modes, or recovery time thresholds indicating how long a user should be allowed to rest after their last alert. These preferences may be input via a user interface and stored locally or in the cloud. The decision logic may use simple conditional statements to select the alert recipient based on these stored parameters, providing a predictable and customizable experience without the complexity of machine learning models. This logic may use threshold-based rules or time-of-night constraints without the need for real-time biometric input, enabling simplified system architecture. Fallback conditions may default to alternating alerts or alerting all available caregivers.

Network-based monitoring where devices such as smart thermostats, smart speakers, connected mattresses, and home security cameras contribute environmental or behavioral data. Each device may collect discrete but complementary information about the environment and user behavior. For example, a smart thermostat may detect room occupancy patterns based on motion sensors or temperature fluctuations; a smart speaker may monitor ambient noise levels or detect vocal cues from an infant; a connected mattress may detect body pressure or movement without requiring worn sensors; and home security cameras may provide visual confirmation of activity within a room. These disparate inputs may be aggregated via a central processor, cloud service, or local hub that analyzes the multi-source data to infer sleep status, room activity, and which individual may be best positioned to respond. The decision engine may prioritize sources based on confidence level, timing, or data freshness, and can adapt over time to user behavior. Such a system may operate independently or in tandem with biometric sensing components. These devices may be coordinated via a central hub or distributed architecture that evaluates data from multiple sources to infer user status and determine alert targets. Sensor fusion techniques such as voting schemes, ensemble classifiers, or time-weighted inputs may be used.

Mobile device-based detection using sensors embedded in smartphones or tablets, such as accelerometers, gyroscopes, microphones, or software-based sleep estimation applications. These devices may be worn, placed nearby, or configured for passive monitoring, reducing reliance on specialized wearable hardware. The device may communicate wirelessly with a base station and provide real-time updates.

In some embodiments, the AI system may also be configured to evaluate the status of the monitored subject, such as a baby, to determine whether assistance is likely to be needed before a full cry or disturbance occurs. This anticipatory assessment may be based on physiological signals including but not limited to heart rate, blood oxygen level, motion patterns, and breathing rate. These signals may be gathered using a wearable device that attaches comfortably to the infant's foot, ankle, arm, hand, or torso and incorporates sensors such as pulse oximeters, accelerometers, and photoplethysmographic (PPG) sensors. The device may be battery-powered, include wireless communication circuitry, and transmit data to a base processor. Precursor patterns of distress may include sustained increases or decreases in heart rate beyond personalized baselines, irregular breathing intervals, heightened movement during sleep, sudden changes in body orientation, or repeated head or limb motions. The AI may identify these patterns using feature extraction and temporal sequence modeling. For example, convolutional neural networks may detect local signal anomalies, while recurrent neural networks or temporal convolutional networks may learn time-dependent relationships that typically precede awakening, discomfort, or a cry.

The system may utilize a machine learning model trained on a variety of labeled event data to distinguish between typical physiological fluctuations and those that precede an actual need for intervention. For example, the model may detect trends indicating that the baby is about to wake in distress, experience a drop in oxygen saturation, or display signs of irregular breathing or agitation. The AI model may then preemptively notify a caregiver before a full waking event occurs, allowing for more effective and timely care. Training data may include timestamps, biometric signals, caregiver response logs, and audio events.

Training datasets used to configure or refine the AI model may include labeled sleep interruptions, which are discrete events during a subject or caregiver's sleep cycle marked by physiological changes or behaviors indicating arousal, distress, or awakening. These may be labeled manually or semi-automatically based on thresholds in heart rate, motion, oxygen saturation, or vocal activity. Caregiver response outcomes may include metadata indicating whether an alert was delivered, acknowledged, ignored, or acted upon, such as through mobile app interaction logs, wearable feedback confirmations, or audio detection of a caregiver entering the room. These outcomes allow supervised training of the AI to correlate subject behavior with effective caregiver engagement, enabling refinement of the alert decision process over time.

In some implementations, the system may replace traditional rule-based alarm thresholds with data-driven predictions, reducing the likelihood of false positives. Rather than relying on static criteria (e.g., a fixed oxygen level threshold), the AI may evaluate trends, rates of change, and historical context to predict adverse events with greater specificity. The model may be periodically refined using anonymized user data and may be configured to learn from caregiver feedback about which alerts were acted on or ignored. The system may also suppress redundant notifications based on alert cooldown timers.

In certain embodiments, the system may also distinguish between false positives and true needs for caregiver intervention. For example, transient movements, spontaneous vocalizations, or normal sleep behavior patterns that do not require attention may be filtered out by the AI model, which is trained to differentiate actionable events from benign activity. This may reduce unnecessary wake-ups and caregiver fatigue. In more advanced configurations, the AI may incorporate feedback loops based on user behavior such as ignoring or overriding alerts to fine-tune its sensitivity and reduce false alerts over time. The system may track false-positive occurrences and adjust its decision boundary thresholds dynamically.

In one embodiment, if the system determines or predicts with high confidence that immediate attention is required for the child's safety such as in response to signs of potential respiratory distress, dangerously low oxygen levels, or convulsive movement the system may automatically alert both caregivers simultaneously regardless of their relative rest state or sleep score. This dual alert protocol ensures that assistance is not delayed in urgent situations and may be triggered by either threshold-based criteria or model-detected high-risk classifications.

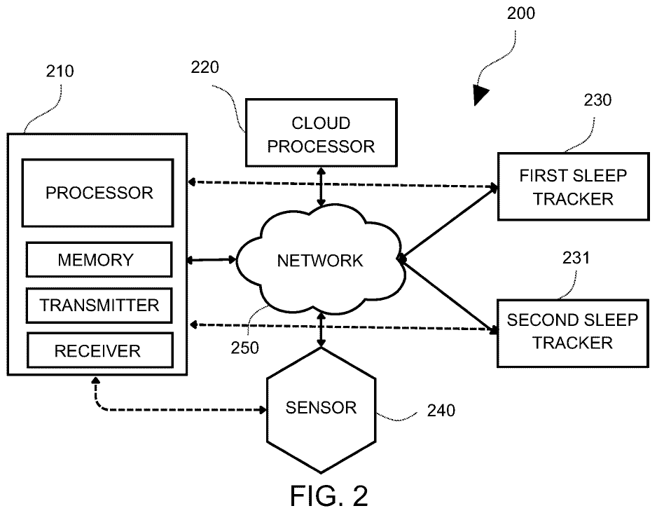

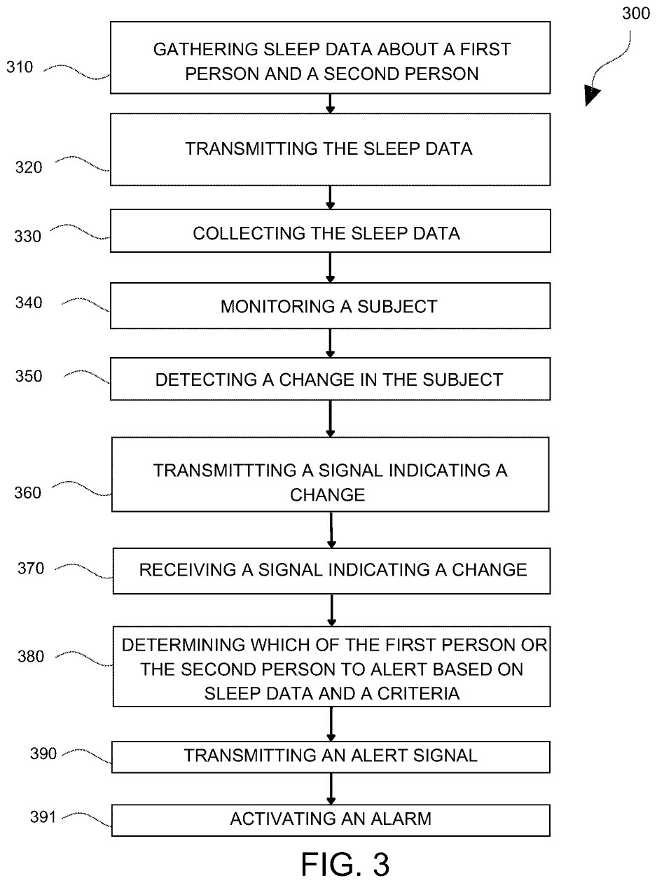

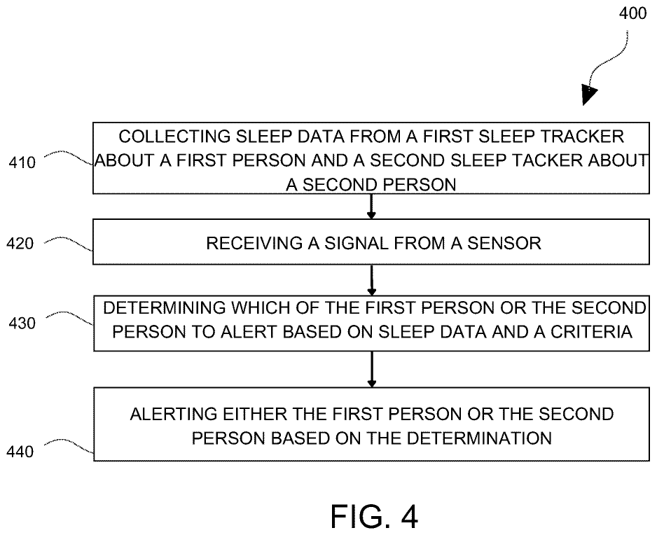

FIG. 2 is a block diagram illustrating a suitable computing environment 200 for the system of an embodiment. Apparatus 210, may be a mobile phone, a virtual voice assistant, or any other suitable hardware. Apparatus 210 comprises a processor, memory, transmitter, and receiver. The memory may include computer readable program code. The memory and the computer readable program code are configured with the processor to perform processes and methods similar to those described in FIGS. 3 and 4. Apparatus 210, may be connected to various different networks 250, such as the internet, a private wifi network, or any other suitable network.

The sensor 240 may also be connected to the cloud processor 220 via the network 250. The sensor 240 may be connected directly to the apparatus 210 or through network 250. The sensor may transmit the signal indicating a change in the subject to the cloud processor 220 in some embodiments and to the apparatus 210 in other embodiments, or both in other embodiments. In some embodiments the processor may be in a sleep tracker 230 or 231.

The first sleep tracker 230 and the second sleep tracker 231 may be connected to the apparatus 210 through the networks 250 or directly, such as via Bluetooth® or any other suitable means. Similar to the sleep trackers 110 and 111 described in FIG. 1, sleep trackers 230 and 231, track the sleep of a first and second person and transmit sleep data to a processor. In certain embodiments, the processor may be a cloud processor 220 that is connected through network 250. The cloud processor 220 may analyze and compare the sleep data and transmit an alert signal directly to an alert device such as a sleep tracker 230 or 231, the apparatus 210, a separate mobile phone, an audio alarm, a haptic alarm, a visual alarm, or mechanical mechanism configured to perform an operation to alert a person. In other embodiments, the cloud processor may transmit the determination to the apparatus and the apparatus will transmit the alert signal to the alert device. The alert device then activates the alarm. The alarm, as discussed above, may be haptic, audio, or visual.

FIG. 3 is a flow diagram illustrating a method 300 for determining which of multiple people to alert when a sensor detects a change according to certain embodiments. The method 300 may be performed by the system described in the environment 100, 200, 500, or 600. It will be appreciated that the method 300 may be performed on any suitable hardware.

In operation 310, the sleep trackers gather sleep data about a first person and a second person. As described above, the sleep trackers gather sleep data by monitoring any number of metrics like body movement, brain activity, heart rate, or blood oxygen level.

In operation 320, the sleep trackers transmit the sleep data to a processor. The transfer could occur via a network or other wireless connection. In operation 330, the processor collects the data received from the sleep trackers. In operation 340, at least one sensor monitors a subject. The subject may be a person, an environment, or anything that a sensor could monitor.

In operation 350, at least one sensor detects a change in the subject. For example, the sensor may detect movement of the baby, screaming or crying, heart rate change, change in bodily temperature, or change in ambient temperature, movement in a certain area, or a specific noise. These types of changes are merely examples meant to be illustrative of the type of change that a sensor might detect but should not be understood to be an exhaustive list.

Additionally, a threshold amount of detected change or a certain combination of detected changes may be required before proceeding to the next operation. For example, the sensor may require continuous movement for an amount of time or in a specific place, screaming for an amount of time or at a certain volume level, reaching a specific body temperature, or reaching a specific ambient temperature. These examples are merely examples of a few types of threshold detections and not an exhaustive list of what could be used. Additionally, in certain embodiments combinations of multiple changes detected and/or thresholds may be used.

In operation 360 the at least one sensor transmits a signal indicating the detected change. In operation 370, the processor receives the signal. The signal may be received directly or indirectly though networks or other devices.

In operation 380, the processor determines which of the first person or the second person to alert based on the sleep data and a criteria. The discussion of criteria above also applies here. The sleep data of the first person and the sleep data of the second person are analyzed based on the criteria to determine which person will be alerted.

In operation 390, the processor transmits an alert signal to an alert device that either the first person or the second person should be alerted based on the determination from operation 380. Each of the first person and the second person have a corresponding alert device. The alert device may also be the corresponding sleep tracker. In operation 391, the alert device activates an alarm that alerts the first or second person. The alarm may be a haptic alarm, audio, alarm, or visual alarm. In certain embodiments with multiple sensors, the processor may transmit a different alert signal corresponding to each detected change or combination of detected change. The alarm may increase in intensity, frequency, magnitude, or volume if the corresponding sleep tracker does not detect that the alerted person has perceived the alarm.

FIG. 4 is a flow diagram illustrating a method 400 for determining which of multiple people to alert when a sensor detects a change according to certain embodiments. The method 400 may be performed by an apparatus or device with a processor or a cloud processor as described in the environment 100, 200, 500, 600, and 700. It will be appreciated that the method 400 may be performed on any suitable hardware.

In an embodiment, operation 410, a processor collects sleep data from a first sleep tracker about a first person and a second sleep tracker about a second person. The processor may receive the sleep data via networks or directly from sleep trackers via wireless connection. As discussed above, the sleep data may be any type of data that the processor uses to analyze the sleep of the first and second person. Some examples of sleep data may include heart rate, sleep status, amount of time slept, current type of sleep, blood oxygen levels, quantity of completed sleep cycles, body movement, brain activity, etc. . . .

In operation 420, the processor receives a signal from at least one sensor indicating a change in a subject monitored by the at least one sensor. As discussed above, the change could be any change detected by a sensor (e.g., motion, visual, audio, temperature, etc. . . . ). Apparatus may receive the signal through networks or directly from the sensor through wireless or wired connection.

In operation 430, the processor determines which of the first person or the second person to alert based on the sleep data and criteria. Multiple criteria and combinations of criteria may be used.

In operation 440, the processor alerts either the first person or the second person based on the determination in operation 430. The alerting may include sending an alert signal to the alert device. In certain embodiments the alert device may be a sleep tracker or designated alarm device. The alert device then activates an alarm alerting either the first person or the second person based on the determination of operation 430. As discussed above, the alarm may be haptic, audio, or visual cue (such as opening curtains or turning on a light).

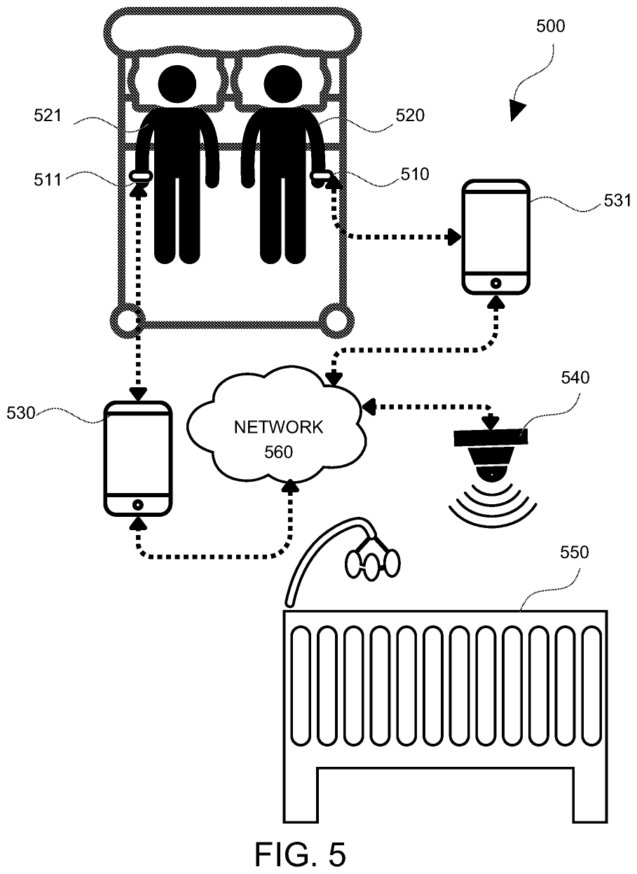

In FIG. 5, a schematic environment 500 of an example embodiment is shown. A first person 520 and a second person 521 of what could be several persons are shown to be asleep. In FIG. 5 the first person 520 has a corresponding sleep tracker 510 and the second person 521 has sleep tracker 511. Each sleep tracker is connected to processor 530 and 531. Each processor 530 and 531 are connected to a network 560 which may be the internet, wifi network, or any other suitable network. or 130. The processors 530 and 531 may be a mobile phone, virtual voice assistant device, cloud processor, a wearable device, or any other suitable processor. The processors 530 and 531 are also connected to at least one sensor 540. The at least one sensor 540 in this embodiment is monitoring a subject 550 (e.g., a baby located in a crib) the subject could be a person, an environment, a thing, or anything that a sensor could monitor. The connection of the processors 530 and 531 and the at least one sensor 540 may be over a network such as wifi or the internet, wired connection, or over a wireless connection type such as Bluetooth®. There may be multiple sensors 540 that are monitoring the same or multiple different subjects 550. The sensor 540 may include any type of sensor (e.g., audio, visual, infrared light emitting devices, non-visible light, thermo, heart rate monitor, blood oxygen, accelerometer, etc. . . . ).

While the first person 520 and the second person 521 are sleeping, the sleep trackers 510 and 511 gather sleep data related to the corresponding person and transmit the data to the processors 530 and 531. When a change that is detectable by sensor 540 occurs in, around, or with the subject 550, sensor 540 sends a signal to processors 530 and 531. Either or both of processors 530 and 531 then analyze the sleep data of persons 520 and 521, and make a determination of which person to alert based on a criteria or combination of criteria.

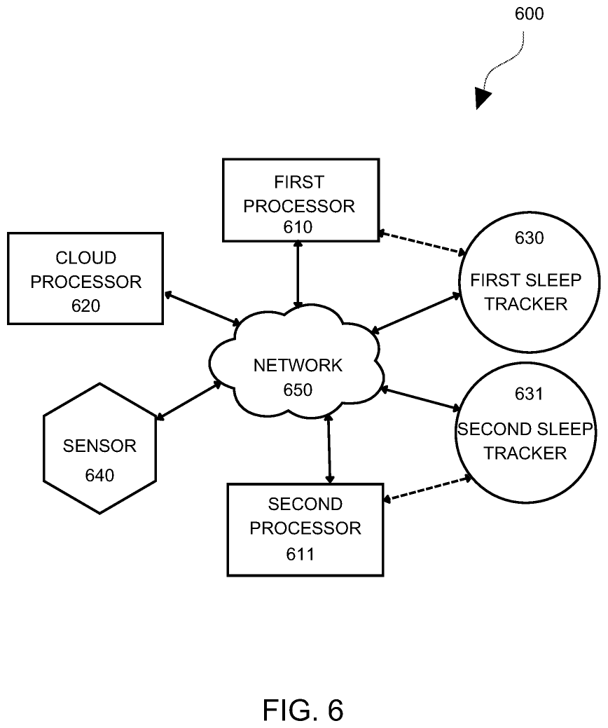

FIG. 6 is a block diagram illustrating a suitable computing environment 600 for the system of an embodiment. First processor 610 and second processor 611, may be mobile phones, virtual voice assistants, or any other suitable hardware. First and second processors 610 and 611 may be apparatuses similar to apparatus 210 comprising a processor, memory, transmitter, and receiver. The memory may include computer readable program code. The memory and the computer readable program code are configured with the processor to perform processes and methods similar to those described in FIGS. 3 and 4. First and second processors 610 and 611, may be connected to various different networks 650, such as the internet, a wifi network, or any other suitable network. The first and second processors 610 and 611 may also be connected to a cloud processor 620 via the network 650.

The sensor 640 may also be connected to the cloud processor 620 via the network 650. The sensor 640 may be connected directly to the first and second processors 610 and 611 or through network 650. The sensor may transmit the signal indicating a change in the subject to the cloud processor 620 in some embodiments and to first and/or second processors 610 and 611 in other embodiments, or all in other embodiments. In some embodiments the processor may be in a sleep tracker 630 or 631.

The first sleep tracker 630 and the second sleep tracker 631 may be connected to the first and second processors 610 and 611 through the networks 650 or directly through a wireless connection, such as via Bluetooth® or any other suitable means. Similar to the sleep trackers 510 and 511 described in FIG. 5, sleep trackers 630 and 631, track the sleep of a first and second person and transmit sleep data to the respective first and second processors 610 and 611. The cloud processor 620 may analyze and compare the sleep data and transmit an alert signal directly to an alert device such as a sleep tracker 630 or 631, first or second processors 610 and 611, a separate mobile phone, an audio alarm, a haptic alarm, a visual alarm, or mechanical mechanism configured to perform an operation to alert a person. In other embodiments, the cloud processor may transmit the determination to the apparatus and the apparatus may transmit the alert signal to the alert device. The alert device then activates the alarm. The alarm, as discussed above, may be haptic, audio, or visual. In other embodiments there may not be a cloud processor 620 and the first processors 610 and/or the second processor 611 make the determination and transmit the alert signal.

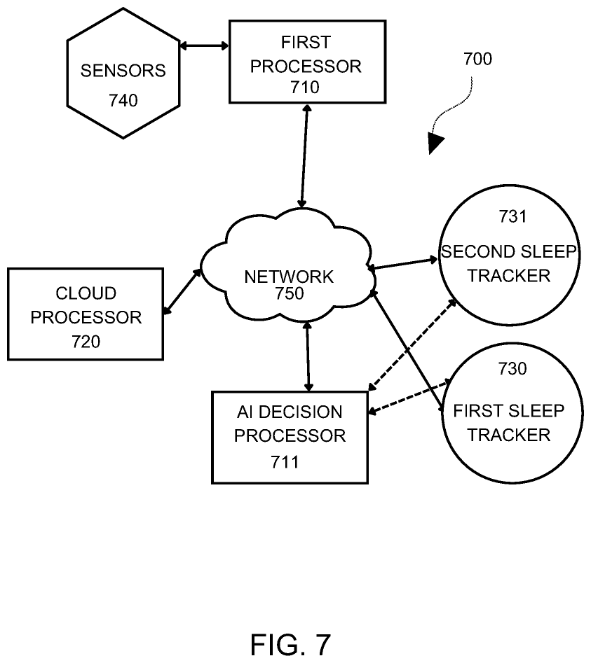

FIG. 7 is a block diagram illustrating a suitable computing environment 700 for the system of an embodiment. First processor 710, may be mobile phones, virtual voice assistants, a dedicated processor, or any other suitable hardware. First processor may be an apparatus similar to apparatus 210 comprising a processor, memory, transmitter, and receiver. The memory may include computer readable program code. The memory and the computer readable program code are configured with the processor to perform processes and methods similar to those described in FIGS. 3 and 4. First processor 710, may be connected to various different networks 750, such as the internet, a wifi network, local area network, or any other suitable network. The first processor 710 may also be connected to a cloud processor 720 via the network 750. The cloud processor could be an AI decision processor similar to AI decision processor 711 but in the cloud instead of local or edge. First and second sleep trackers 731 and 730 are similar to other sleep trackers described above.

Embodiments or aspects of embodiments may be combined where possible.

For clarity of explanation, in some instances the present technology may be presented as including individual functional blocks including functional blocks comprising devices, device components, steps or routines in a method implemented in software, or combinations of hardware and software.

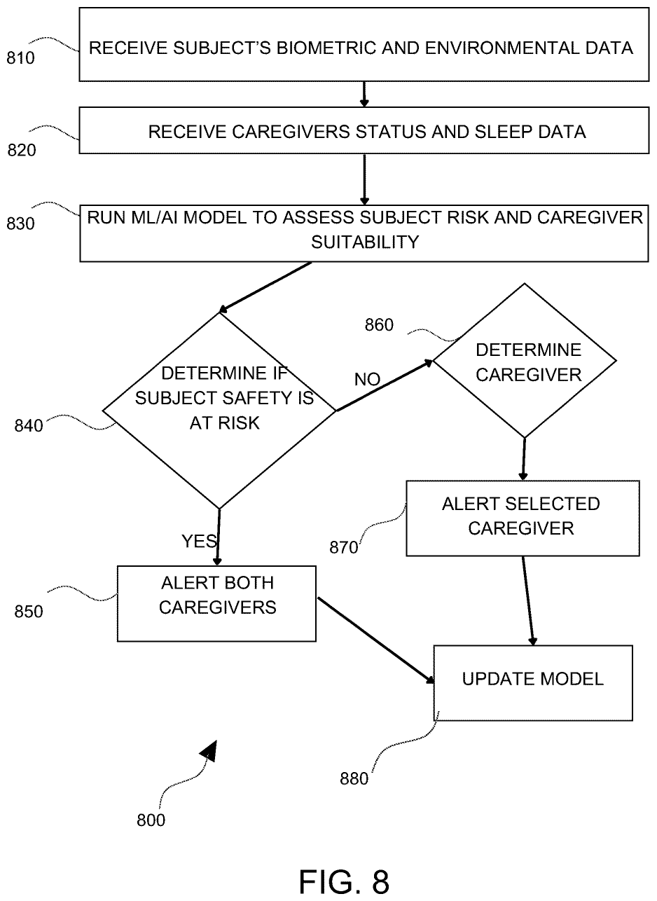

FIG. 8 is a flow diagram illustrating a method 800 for determining which of multiple people to alert when a sensor detects a change according to certain embodiments. The method 800 may be performed by an apparatus or device with a processor or a cloud processor as described in the environment 100, 200, 500, 600, and 700. It will be appreciated that the method 800 may be performed on any suitable hardware.

In operation 810, the processor receives a signal from at least one sensor indicating a change in a subject monitored by the at least one biometric sensor or environmental sensor. As discussed above, the change could be any change detected by a sensor. In operation 820, the processor receives the caregivers' status and sleep data. The status and sleep data are discussed above.

In operation 830, the processor runs the ML/AI model to assess subject's risk and the caregivers' suitability. In operation 840, the processor determines if the subject needs immediate attention from either caregiver. If no immediate attention is required, then operation 860 determines which caregiver is optimum or in best status to attend to the subject. Operation 870 alerts the determined caregiver. If the determination of 840 is that the subject needs immediate attention, operation 850 alerts both parents. Operation 880 updates the model based on the results of the previous operations.

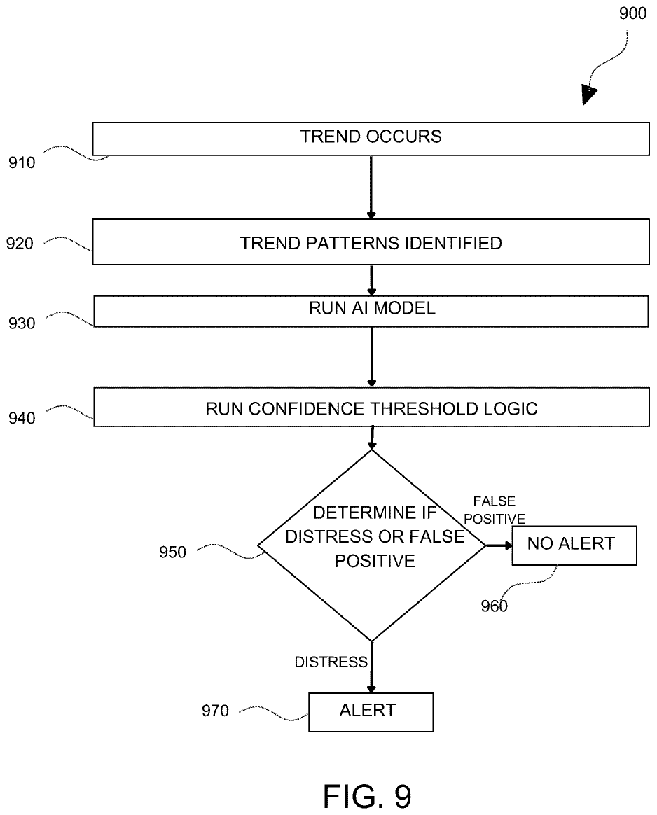

FIG. 9 is a flow diagram illustrating a method 900 for determining which of multiple people to alert when a sensor detects a change according to certain embodiments. The method 900 may be performed by an apparatus or device with a processor or a cloud processor as described in the environment 100, 200, 500, 600, and 700. It will be appreciated that the method 900 may be performed on any suitable hardware.

In 910, a trend occurs and in operation 920 the trend pattern is identified. In operation 930, the AI/ML model is run and triggered by the identification of the trend pattern. The AI/ML determines a confidence level that that the trend pattern will result in the event associated with the trend. In operation 940 the confidence threshold logic is run and in operation 950 a determination is made whether the identified trend pattern is indicative of distress or if it is a false positive. If a false positive is determined, operation 960 performs no alerts and updates the model. If actual distress is determined, operation 970 sends an alert.

In some instances, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, program code, media for conveying such instructions, computing resources for executing them, and other structures for supporting such computing resources are example means for providing the functions described in the disclosure.

In the foregoing description, aspects of the application are described with reference to specific examples and aspects thereof, but those skilled in the art will recognize that the application is not limited thereto. Thus, while illustrative examples and aspects of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, examples and aspects of the systems and techniques described herein can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

Where components are described as being configured to perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Methods and apparatus of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Such methods may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

### Enhanced Embodiments

The following sections describe enhanced embodiments that extend and supplement the disclosure of the parent application. These embodiments provide additional technical detail regarding specific implementations of the caregiver alerting system, including a hub multi-protocol coordination architecture, an asymmetric accumulation model for sustained audio event detection, a wakeability scoring pipeline derived from heart rate variability data, a multi-path alert delivery mechanism with deduplication, a multi-layer reliability architecture for continuous overnight monitoring, proximity-based alert suppression, safety-gated firmware updates, and cloud-first routing with local fallback capability. These enhanced embodiments may be practiced individually or in combination with any of the embodiments described above.

### System Overview and Hub Multi-Protocol Coordination Architecture

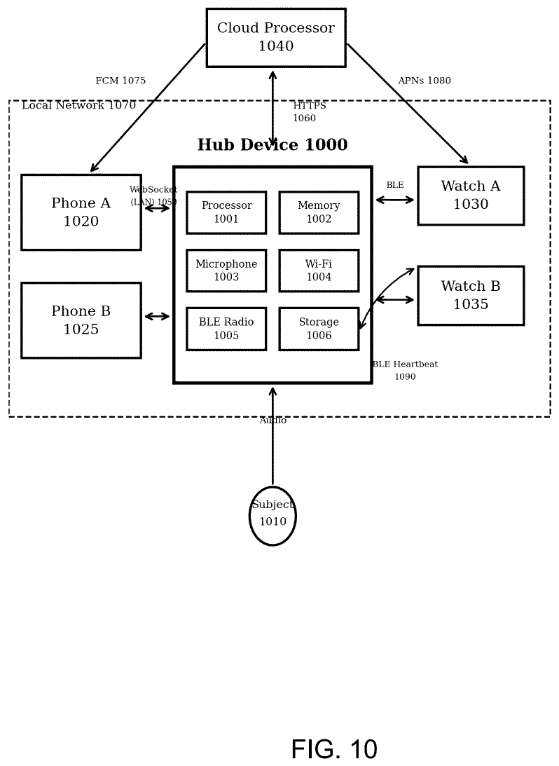

Referring now to FIG. 10, a block diagram illustrates a system overview of a multi-person baby monitor alarm system 1000 comprising a hub device, caregiver smartphones, caregiver wearable devices, and a cloud processor in accordance with various aspects of the subject technology.

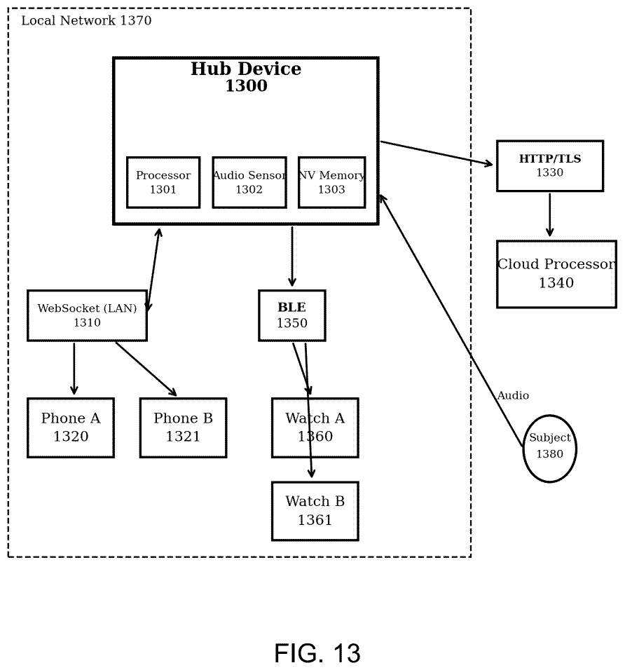

Referring now to FIG. 13, a block diagram illustrates a hub multi-protocol coordination architecture 1100 in accordance with various aspects of the subject technology. The architecture addresses the technical problem of coordinating real-time physiological monitoring, audio event detection, and targeted alert routing across multiple heterogeneous communication protocols and device types.

A hub device 1100 comprises a processor 1101, a memory, an audio sensor 1110, and a plurality of communication interfaces. The hub device 1100 is positioned in proximity to a monitored subject, such as within a nursery or sleeping area. In certain embodiments, the hub device 1100 comprises an embedded computing platform, such as a microcontroller-based system, executing firmware that implements the monitoring, detection, and routing functions described herein.

As used herein, the terms ‘hub device,’ ‘coordination device,’ and ‘monitoring device’ are used interchangeably to refer to any device positioned in spatial proximity to the monitored subject and configured to detect events, receive sensor data, and coordinate alert routing decisions. Such devices include dedicated hardware appliances designed for infant monitoring, general-purpose smartphones acting in the role of monitoring hub, smart speakers and voice assistants functioning as edge computing nodes, purpose-built embedded systems, and edge computing appliances with local processing capability.

The hub device 1100 communicates via a first communication protocol 1050 with a plurality of caregiver devices, including a first caregiver smartphone 1020 and a second caregiver smartphone 1025. In certain embodiments, the first communication protocol 1050 comprises a persistent bidirectional connection, such as a WebSocket connection, established over a local wireless network. The persistent bidirectional connection enables low-latency, real-time transmission of event data from the hub device 1100 to the caregiver smartphones and reception of control commands from the caregiver smartphones to the hub device 1100.

As used herein, the term ‘communication protocol’ refers to any defined set of rules and specifications governing the exchange of data between electronic devices across a network or direct communication link. Communication protocols explicitly include but are not limited to WebSocket connections, HTTP and HTTPS protocols, the MQTT publish-subscribe protocol, the Constrained Application Protocol (CoAP), the gRPC remote procedure call framework, Bluetooth Low Energy (BLE), Wi-Fi and 802.11 wireless protocols, Zigbee, Thread, Matter, Near-Field Communication (NFC), and cellular protocols including LTE, 5G, and similar mobile network standards.

The hub device 1100 communicates via a second communication protocol 1060 with a cloud processor 1040, such as a cloud-based server infrastructure. In certain embodiments, the second communication protocol 1060 comprises authenticated HTTP requests transmitted over a secure network connection. Each request includes a timestamp and a signature computed using a hash-based message authentication code (HMAC) over a concatenation of the timestamp and the request payload, using a secret key stored in non-volatile memory of the hub device 1100.

The hub device 1100 communicates via a third communication protocol 1130 with wearable devices 1030 associated with the caregivers, such as smartwatches. In certain embodiments, the third communication protocol 1130 comprises a short-range wireless protocol, such as Bluetooth Low Energy (BLE), used for device provisioning, heartbeat signaling to maintain background execution of companion applications on the wearable devices, and proximity detection as described below.

The hub device 1100 executes a plurality of concurrent tasks organized in a priority hierarchy. An audio detection task executes at the highest priority level, ensuring that monitoring of the audio sensor 1110 for events associated with the monitored subject is not interrupted by network communication operations. Network communication tasks for the first, second, and third communication protocols execute at lower priority levels. This priority arrangement ensures deterministic audio event detection timing regardless of network activity.

The hub device 1100 maintains a locally cached copy of caregiver state data in the memory. The caregiver state data includes, for each registered caregiver device, at least a connection status, a most recent wakeability score computed by the cloud processor 1040, and a current alert routing mode. When the network connection to the cloud processor 1040 is available, the hub device 1100 transmits event data and caregiver physiological data to the cloud processor 1040 to obtain a routing decision. When the network connection to the cloud processor 1040 is unavailable, the hub device 1100 executes a local routing decision using the locally cached caregiver state data, selecting the caregiver with the highest cached wakeability score as the target for alert routing.

The hub device 1100 is configured to register up to a predetermined number of caregiver devices, such as four caregiver devices. Each registered caregiver device is assigned a persistent role identifier stored in non-volatile memory of the hub device 1100. The registration persists across power cycles and is restored automatically upon restart of the hub device 1100.

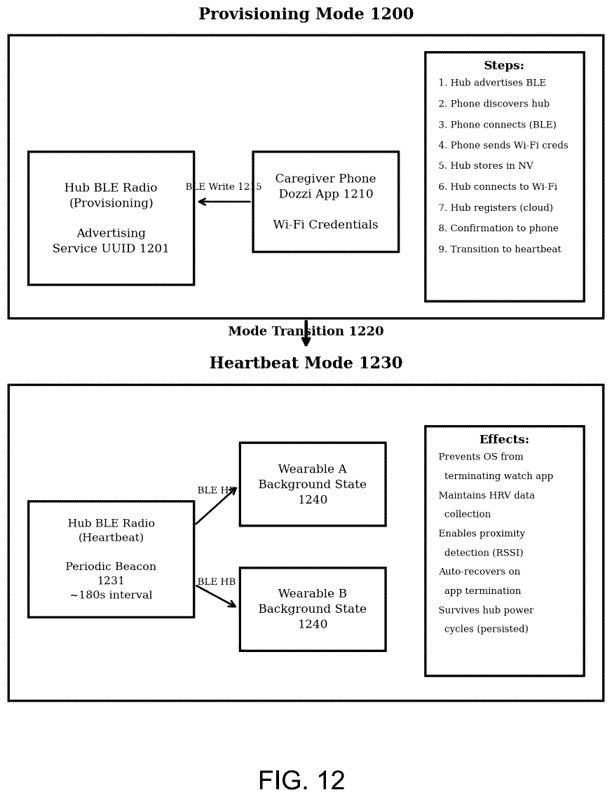

Referring now to FIG. 12, a diagram illustrates BLE provisioning and heartbeat modes of the hub device in accordance with various aspects of the subject technology. The short-range wireless radio of the hub device 1100 operates in at least two modes. During an initial provisioning phase, the short-range wireless radio operates in a first mode in which it receives network credentials from a caregiver device. The network credentials include information required for the caregiver device to connect to the local wireless network and establish a connection with the hub device 1100 via the first communication protocol 1050. Upon completion of provisioning, the short-range wireless radio transitions to a second mode in which it transmits periodic heartbeat signals that maintain a background execution state of companion applications on the caregiver wearable devices 1030.

In alternative embodiments, the first communication protocol 1050 may employ protocols other than WebSocket. In certain embodiments, the hub device may use MQTT (Message Queuing Telemetry Transport) as the local communication protocol, in which the hub operates as an MQTT broker and each caregiver smartphone subscribes to a topic associated with its caregiver identifier. In certain embodiments, the hub may use CoAP (Constrained Application Protocol) for lightweight communication suitable for resource-constrained devices. In alternative embodiments, the hub device may expose a gRPC (Google Remote Procedure Call) interface, enabling caregiver devices to invoke typed service methods rather than exchanging raw JSON payloads. These protocol alternatives are functionally equivalent to WebSocket in that they support bidirectional real-time message exchange between the hub and caregiver devices and do not limit the scope of the hub coordination architecture.

In certain embodiments, the authentication mechanism used with the second communication protocol 1060 may be substituted with alternative cryptographic methods. In alternative embodiments, the hub device may authenticate with the cloud processor using a JSON Web Token (JWT) signed with a private key stored in a secure element on the hub, rather than HMAC-SHA256 with a shared secret. In certain embodiments, the hub may use OAuth 2.0 client credentials grant to obtain a short-lived access token from an authorization server, presenting the access token as a Bearer token in each HTTP request. In alternative embodiments, mutual TLS (mTLS) authentication may be employed, in which both the hub device and the cloud processor present X.509 certificates during the TLS handshake, eliminating the need for application-layer authentication. Each of these authentication alternatives provides equivalent security guarantees:
the cloud processor can verify that requests originate from an authorized hub device, and the hub device can verify the identity of the cloud processor.

In alternative embodiments, the provisioning interface may use technologies other than BLE. In certain embodiments, Near Field Communication (NFC) may be used for provisioning, wherein the caregiver holds their smartphone adjacent to the hub device and network credentials are transferred via NFC Data Exchange Format (NDEF) records. In certain embodiments, provisioning may be accomplished through a QR code displayed on a label affixed to the hub device or rendered on a display of the hub device, which the caregiver scans using a camera on the caregiver smartphone. The scanned QR code encodes the hub device identifier, a provisioning key, and a local network SSID, enabling the caregiver smartphone to establish an initial connection. These provisioning alternatives do not alter the subsequent normal-mode operation of the hub device and do not limit the scope of the BLE heartbeat mechanism described above.

In certain embodiments, the hub function may be distributed rather than concentrated in a dedicated hardware device. In alternative embodiments, the hub logic (audio sensing, event detection, session management, caregiver roster, routing decisions) may execute as a software application on a caregiver smartphone. The smartphone serving as the hub is placed in proximity to the monitored subject and uses its built-in microphone for audio detection. Routing decisions may be made locally on the smartphone or delegated to the cloud processor as described above. In certain embodiments, the hub function may be implemented on a smart speaker, a smart display, or another consumer electronic device with a microphone and network connectivity. The distributed-hub variant provides functional equivalence to the dedicated-hub architecture in that it coordinates selective alerting across multiple caregiver devices based on audio events and physiological data.

In alternative embodiments, the hub may coordinate with caregiver devices using a mesh networking protocol. In certain embodiments, Zigbee, Thread, or Matter (formerly Project CHIP) may provide the local communication fabric, enabling multiple hub devices to relay messages to caregiver devices even in scenarios with limited direct connectivity. In such embodiments, each node in the mesh may cache a subset of caregiver state data, providing further redundancy for local routing decisions. The mesh-based communication variant does not alter the logical architecture of event detection, session management, or routing decisions.

### Cry Session Lifecycle State Machine

As used herein, the term ‘monitoring session’ refers to a bounded period of time during which alert routing decisions are constrained to a single designated target caregiver, treated as a transactional unit with defined start and end points. A monitoring session persists across multiple detected events and may span several hours, during which alerts generated from the same monitored subject are consistently routed to the designated caregiver rather than distributed among multiple recipients.

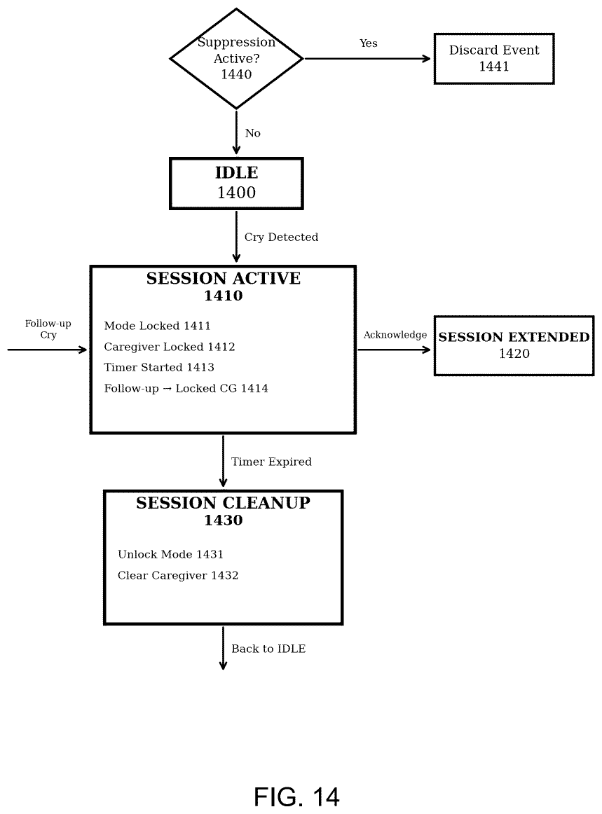

Referring now to FIG. 14, a state diagram illustrates a cry session lifecycle state machine 1400 in accordance with various aspects of the subject technology. The state machine manages the routing behavior of the system during and between monitoring events, treating each cry event as a transactional unit with defined lifecycle stages.

The state machine comprises a plurality of states including at least an idle state 1410, an active session state 1420, a snooze state 1430, a feeding state 1440, and a response window state 1450. Transitions between states are triggered by events detected by the hub device 1100, by timer expirations, or by commands received from caregiver devices.

In the idle state 1410, the hub device 1100 monitors for audio events using the asymmetric accumulation model described below. Upon detection of a sustained audio event, the state machine transitions to the active session state 1420.

Upon entering the active session state 1420, the hub device 1100 determines a target caregiver based on a current alert routing mode. The alert routing mode is one of: a smart mode in which the target caregiver is selected based on the wakeability score and effective score described below; an alternating mode in which the target caregiver alternates between successive sessions; a schedule mode in which the target caregiver is determined based on a time-of-day schedule; or a broadcast mode in which alerts are transmitted to all registered caregivers. In the schedule mode, the hub device 1100 receives a timezone offset value from a caregiver device, computes a local time by applying the timezone offset to a coordinated universal time maintained by the hub device, and determines which caregiver is assigned to a current shift based on a comparison of the computed local time to a configurable shift boundary.

As used herein, the term ‘alert routing mode’ refers to a configurable mode or policy that determines how the system selects a target caregiver to receive alerts generated during a monitoring session. Alert routing modes include smart mode wherein the system dynamically selects the caregiver with the highest current wakeability score or other readiness metric, alternating mode wherein alerts are distributed sequentially among multiple caregivers, schedule mode wherein alert routing follows a predetermined time-based schedule, broadcast mode wherein all caregivers receive alerts simultaneously, and any user-defined or custom routing policy configured through system settings. Each mode may be more useful in different situations. For example, if the subject is tending to wake up several times per night, the schedule-based system may be the best solution because it allows each caregiver to obtain a significant amount of time of uninterrupted sleep, where alternating or smart may still lead to frequent interruptions. Alternatively, if the subject seems to wake up certain times of night that lead to an unequal distribution of alerts, it may be more favorable to use alternating mode. The system may recognize patterns identify a recommended strategy based on the subject's history of events, the caregiver's physiological data, and the sleep goals of the caregiver. This pattern recognition may be done through the use of AI models and/or machine learning.

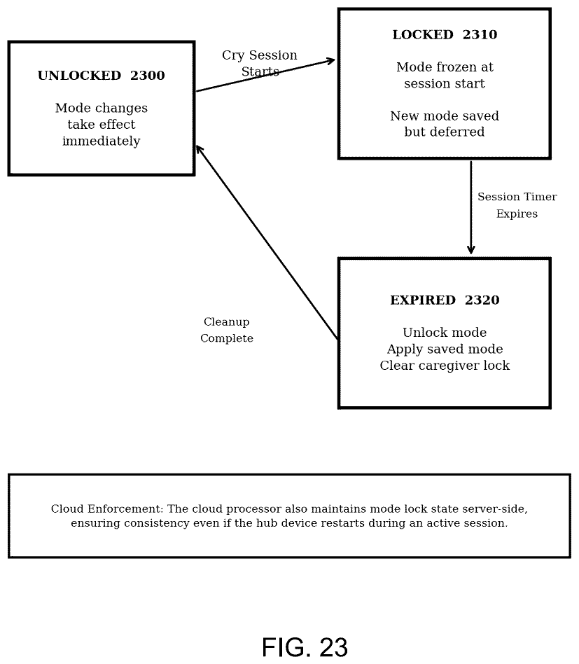

Referring now to FIG. 23, a state diagram illustrates session mode locking during an active monitoring session. The active session state 1420 initiates a monitoring session having a defined duration, such as three minutes. During the monitoring session, the state machine locks the current alert routing mode and the target caregiver assignment, preventing changes to the routing configuration from altering the routing of alerts within the current session. If additional audio events are detected during the active session, the hub device 1100 routes follow-up alerts to the same target caregiver without re-evaluating the routing decision.

The system enforces a minimum interval between successive alerts. Events detected within a predetermined time period, such as three seconds, following a most recent transmitted alert are discarded to prevent alert flooding during sustained crying episodes.

The active session state 1420 may transition to the snooze state 1430 upon receipt of a snooze command from the target caregiver device. In the snooze state 1430, audio events are detected but discarded without generating alerts for a configurable snooze duration. Upon expiration of the snooze duration, the state machine returns to the idle state 1410.

The active session state 1420 may transition to the feeding state 1440 upon receipt of a feeding indication from a caregiver device. In the feeding state 1440, audio events are suppressed for a configurable feeding duration, such as thirty minutes, on the basis that the caregiver is already attending to the monitored subject. Upon expiration of the feeding duration, the state machine returns to the idle state 1410.

The active session state 1420 may transition to the response window state 1450 upon receipt of an acknowledgment from the target caregiver. In the response window state 1450, the session timer is extended by a predefined extension period, such as three additional minutes, providing the caregiver additional time to attend to the monitored subject without triggering additional alerts.

The snooze state 1430, feeding state 1440, and response window state 1450 are mutually exclusive suppression windows. Only one suppression window may be active at any given time. Entry into any suppression window cancels any other active suppression window.

When the target caregiver device is not connected to the hub device 1100 at the time of alert transmission, the hub device 1100 transmits the alert to all connected caregiver devices as a broadcast fallback and additionally transmits the event to the cloud processor 1040 for delivery via a push notification service.

Upon expiration of the monitoring session timer without acknowledgment, the state machine returns to the idle state 1410, clearing the target caregiver assignment and unlocking the alert routing mode for the next event.

In certain embodiments, the session timer duration may be dynamically adjusted based on contextual factors rather than fixed at a predetermined value. In alternative embodiments, the hub may analyze the caregiver's interaction history (average response time over the past N alerts) and set the session timer to 1.5 times the average response time, providing a personalized timeout that adapts to each caregiver's behavior. In certain embodiments, the timer may also be influenced by alert intensity: higher-intensity cry events (determined by the accumulation model's peak value) may trigger longer session timers to provide additional response time, while lower-intensity events trigger shorter timers. This adaptive timer approach preserves the session lock semantics described above while allowing the system to optimize for individual caregiver response patterns.

In alternative embodiments, the session lock may be implemented as a priority queue rather than a binary lock. In certain embodiments, the hub maintains an ordered list of caregiver candidates ranked by effective score. The session lock assigns the highest-ranked caregiver as the primary target, and if the primary target does not acknowledge within a first timeout (e.g., 60 seconds), the lock automatically advances to the next caregiver in the queue without requiring full session expiration. This queue-based approach enables faster escalation while preserving the transactional session semantics: within a single session, routing progresses through the queue in deterministic order.

In certain embodiments, the smart routing mode may be augmented with predictive or machine learning capabilities. In alternative embodiments, instead of selecting the caregiver with the highest current wakeability score, the hub may apply a predictive model trained on historical alert response data. The predictive model receives as inputs the current time of day, the day of the week, and the physiological state indicators for each caregiver, and outputs a predicted response probability for each caregiver. The caregiver with the highest predicted response probability is selected as the target. In certain embodiments, the predictive model may be a simple logistic regression model trained on locally stored data; in alternative embodiments, it may be a neural network model periodically updated via the cloud processor. This predictive routing variant is functionally equivalent to the score-based approach in that it selects the most responsive caregiver, but leverages learned patterns rather than instantaneous physiological data.

In alternative embodiments, the broadcast fallback when the target caregiver is disconnected may be implemented as a sequential escalation rather than simultaneous broadcast. In certain embodiments, the hub contacts the next-highest-ranked caregiver first, waits a configurable timeout (e.g., 15 seconds), and only contacts subsequent caregivers if no acknowledgment is received. This sequential escalation reduces unnecessary alerts to caregivers who are not needed, while the adaptive timeout for each caregiver is tuned based on historical response latency for that caregiver (faster responders receive shorter timeouts before escalation proceeds to the next caregiver).

### Hub Device Hardware and Firmware Architecture

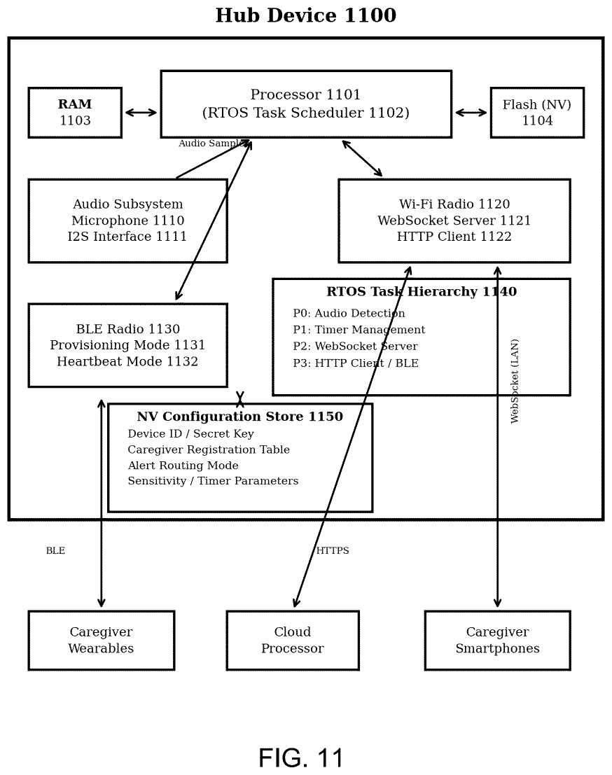

Referring now to FIG. 11, a block diagram illustrates the hub device hardware and communication interfaces in accordance with various aspects of the subject technology. The hub device 1100 comprises a processor 1101, such as an ESP32-S3 dual-core microprocessor, operating at a clock frequency suitable for real-time audio processing and concurrent network communication. The processor 1101 is coupled to a random access memory (RAM) for runtime data storage and a non-volatile flash memory for firmware storage, configuration data, and persistent state.

The audio sensor 1110 comprises a digital MEMS (Micro-Electro-Mechanical Systems) microphone connected to the processor 1101 via an Inter-IC Sound (I2S) digital audio interface. The I2S interface provides a direct digital audio data path from the microphone to the processor, eliminating the need for an analog-to-digital converter and reducing susceptibility to analog noise.

The hub device 1100 further comprises a Wi-Fi radio for connection to a local wireless network and communication with caregiver smartphones via WebSocket and with the cloud processor via HTTPS. A Bluetooth Low Energy (BLE) radio provides the short-range wireless interface for device provisioning and wearable device heartbeat signaling. In certain embodiments, the Wi-Fi and BLE radios are integrated into the processor 1101 as on-chip peripherals.

The firmware of the hub device 1100 implements a real-time operating system (RTOS) task architecture. The tasks include, in order of priority: an audio detection task that reads samples from the I2S interface and implements the asymmetric accumulation model; a timer management task that manages session timers, suppression window timers, and heartbeat intervals; a WebSocket server task that handles bidirectional communication with caregiver smartphones; an HTTP client task that communicates with the cloud processor; and a BLE task that manages device provisioning and heartbeat signaling. A mutual exclusion mechanism, such as a mutex or semaphore, protects shared state data structures accessed by multiple tasks, preventing data races and ensuring consistency.

The hub device 1100 stores a device configuration in non-volatile memory comprising: a unique device identifier, a secret key for HMAC authentication, a caregiver registration table, a current alert routing mode, sensitivity parameters for the audio detection model, session timer durations, and network connection parameters. The configuration survives power cycles and is restorable without user intervention.

### Asymmetric Accumulation Model for Sustained Audio Event Detection

As used herein, the term ‘sustained audio event’ refers to an audio event that persists for a duration exceeding a minimum temporal threshold, such as an infant's cry lasting greater than approximately 500 milliseconds, as distinguished from transient environmental noise, mechanical sounds, or acoustic impulses of shorter duration that do not warrant caregiver alerting.

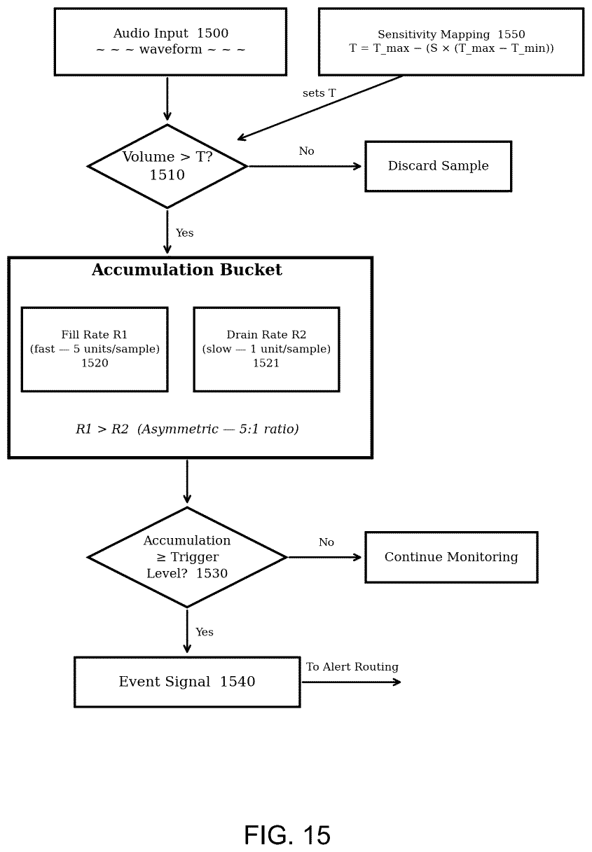

Referring now to FIG. 15, a diagram illustrates an asymmetric accumulation model 1500 for sustained audio event detection in accordance with various aspects of the subject technology. The accumulation model addresses the technical problem of discriminating between transient noise and sustained audio events that indicate a need for caregiver intervention.

The hub device 1100 continuously samples audio data from the audio sensor 1110. In certain embodiments, the audio sensor 1110 comprises a MEMS microphone connected to the processor 1101 via an Inter-IC Sound (I2S) digital audio interface. The processor 1101 reads samples from the I2S interface and computes an audio volume metric from the sampled data. In one embodiment, the audio volume metric is computed as a difference between a maximum sample value and a minimum sample value within a processing window, divided by a scaling factor. The scaling factor normalizes the raw digital sample values to a range suitable for comparison against the configurable threshold.

The processor 1101 maintains an accumulation value that represents the temporal persistence of above-threshold audio activity. The accumulation value increases when the audio volume metric exceeds a configurable threshold 1510 and decreases when the audio volume metric is at or below the configurable threshold 1510. The increase rate, designated as a fill rate R1 (1520), is greater than the decrease rate, designated as a drain rate R2 (1521), creating an asymmetric response characteristic. In one embodiment, the fill rate R1 is five units per sample period and the drain rate R2 is one unit per sample period, yielding a ratio of five to one.

As used herein, the terms ‘accumulation value’ and ‘temporal persistence value’ refer to running computed values used for temporal filtering and hysteresis in event detection systems. Such values increase when a measured parameter exceeds a configured threshold and decrease when the parameter falls below the threshold, allowing the system to distinguish between sustained events and transient fluctuations, and providing temporal context for alert generation decisions.

The asymmetric response characteristic produces several technical effects. The faster fill rate causes the accumulation value to rise rapidly during periods of sustained above-threshold audio, enabling prompt detection of sustained distress events. The slower drain rate causes the accumulation value to decay gradually during brief pauses in the audio pattern, such as momentary gaps between cries, preventing premature reset of the accumulation and allowing detection of sustained events with intermittent characteristics. In combination, the asymmetric rates create a temporal filter that passes sustained audio patterns while rejecting transient noise spikes.

The processor 1101 determines that a sustained audio event has occurred when the accumulation value reaches or exceeds a predetermined trigger level 1530. In one embodiment, the trigger level is fifty units, meaning that at a fill rate of five units per sample period, at least ten consecutive above-threshold sample periods are required to trigger an event in the absence of any below-threshold periods. In practice, the intermittent nature of crying means that more calendar time elapses before the trigger level is reached, and the specific duration depends on the ratio of above-threshold to below-threshold periods.

Upon determining that a sustained audio event has occurred, the processor 1101 transmits an event signal 1540 to the alert routing module and resets the accumulation value to zero. The reset prepares the accumulation model for detection of a subsequent event.

The configurable threshold 1510 is dynamically adjustable during operation. A caregiver device may transmit a sensitivity command to the hub device 1100 via the first communication protocol 1050. The hub device 1100 maps the user-selected sensitivity value to the configurable threshold using a mapping function 1550. In one embodiment, the mapping function computes the threshold as: T=T_max minus the product of the sensitivity value S and the difference between T_max and T_min, where T_max is a maximum threshold value, T_min is a minimum threshold value, and S is a normalized sensitivity value between zero and one. Higher sensitivity values produce lower thresholds, causing the accumulation model to respond to quieter audio events. The mapping function parameters are calibrated to the output characteristics of the specific microphone and I2S interface used in the hub device 1100. The threshold update is applied atomically using the mutual exclusion mechanism described above, ensuring thread-safe modification during active monitoring.

In alternative embodiments, the accumulation model may use different asymmetric ratios tuned for specific monitoring environments. For example, a noisier environment may benefit from a higher fill-to-drain ratio, such as ten to one, to more aggressively reject transient noise. A quieter environment may use a lower ratio, such as three to one, to provide faster detection of lower-amplitude sustained events. In further alternative embodiments, the accumulation model may apply adaptive thresholding based on a running average of ambient noise levels, automatically adjusting the configurable threshold in response to changes in the baseline noise floor. These alternatives do not limit the scope of the fixed-ratio asymmetric model described above.

The audio detection task that implements the accumulation model executes at the highest priority level in the task hierarchy of the hub device 1100, as described above. This priority assignment ensures that audio sampling occurs at a consistent rate regardless of network communication activity, timer processing, or other concurrent operations. The technical effect is that detection latency is bounded to within a small number of sampling intervals, providing predictable event detection timing.

In certain embodiments, the fill rate and drain rate of the accumulation model may be determined dynamically based on audio spectral characteristics rather than being fixed constants. In alternative embodiments, the hub may analyze the frequency content of the audio stream and identify dominant frequency bands (e.g., fundamental cry frequency typically ranges 500 -1500 Hz). When audio energy within the cry frequency range exceeds a threshold, the fill rate is increased; when energy drops below the threshold, the drain rate is increased. This adaptive rate mechanism can improve discrimination between crying and other household sounds (speech, music) that occupy different frequency bands. In certain embodiments, the fill rate and drain rate ratio may remain fixed (e.g., 5:1) while their absolute values scale based on spectral analysis.

In alternative embodiments, the accumulation bucket may employ a symmetric fill and drain architecture (equal rates) combined with a non-linear threshold function, rather than asymmetric rates. In certain embodiments, the accumulation value increases whenever audio exceeds a base threshold and decreases whenever audio drops below the threshold, with fill and drain rates equal. However, the trigger threshold for alert generation is set at a much higher level (e.g., 80% of bucket capacity) compared to the baseline threshold (20%), creating effective asymmetry in practical terms. This symmetric-rate variant achieves similar alert selectivity while simplifying the rate parameter tuning.

In certain embodiments, instead of a single accumulation bucket, the system may maintain multiple accumulators operating in parallel on different frequency bands (e.g., low-frequency cries, high-frequency distress sounds, sustained vs. intermittent patterns). The final cry detection decision is made only if two or more independent accumulators exceed their respective thresholds, implementing a multi-band coincidence detection. In alternative embodiments, the multiple accumulators may feed into a weighted voting scheme in which an accumulator with strong historical correlation to confirmed cries has higher voting weight than accumulators with weaker correlation. This multi-band approach improves robustness against false positives from single-frequency noise sources.

In alternative embodiments, the accumulation model may be replaced with a sliding-window RMS (root-mean-square) energy detector combined with machine learning classification. In certain embodiments, the hub computes rolling RMS energy over 100 ms windows and applies a trained neural network classifier (trained on labeled cry and non-cry audio samples) to classify each window as cry or non-cry. Windows classified as cry contribute to a confidence accumulator, and an alert is triggered when the confidence accumulator exceeds a threshold over a minimum duration (e.g., 500 ms of continuous high-confidence cry windows). This ML-based approach is functionally equivalent to the asymmetric accumulation model in that it detects sustained cry-like audio patterns while rejecting brief noise transients, but it leverages learned feature representations rather than hand-crafted spectral thresholds.

In certain embodiments, the audio task priority level may vary dynamically based on system load. In alternative embodiments, if other critical tasks (e.g., wearable BLE communication during a connection window) are executing, the audio task priority may be temporarily elevated to ensure that cry detection is not starved by lower-priority tasks. In certain embodiments, the hub may implement a priority ceiling protocol in which tasks are assigned a static priority level (audio task has highest ceiling), and the hub uses hardware or OS mechanisms to prevent priority inversion (lower-priority tasks blocking higher-priority tasks from execution). This dynamic priority management ensures that audio processing maintains consistent latency even under high system load.

### Wakeability Scoring Pipeline

As used herein, the term ‘wakeability score’ refers to a computed metric representing the readiness and physiological capacity of a caregiver to be awakened from sleep and respond to an alert, derived from one or more physiological inputs including but not limited to heart rate variability, motion patterns, respiratory rate, and temporal indicators such as time since sleep onset. A higher wakeability score indicates greater readiness and lower physiological cost to awaken the caregiver, whereas a lower score indicates the caregiver is in deep sleep or otherwise less available to respond.

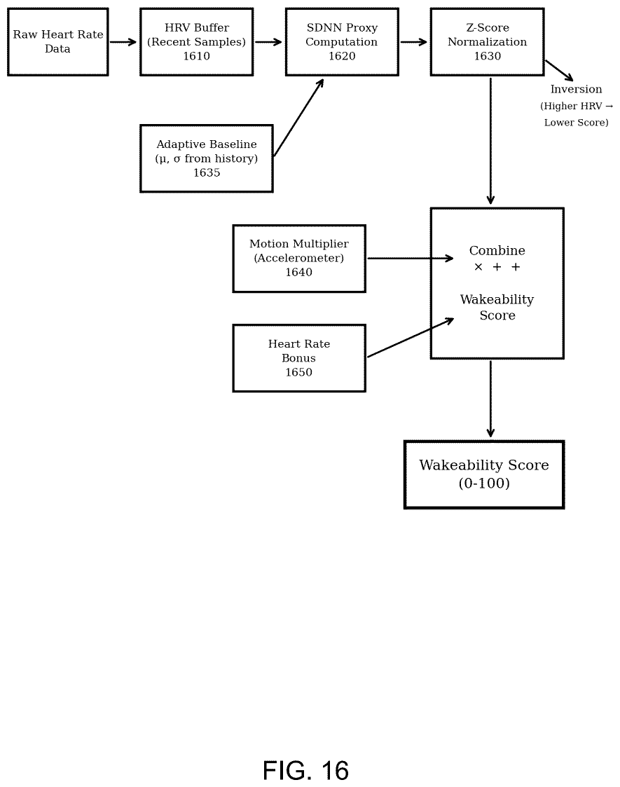

Referring now to FIG. 16, a pipeline diagram illustrates a wakeability scoring pipeline in accordance with various aspects of the subject technology. The system computes a wakeability score for each caregiver that represents the readiness of the caregiver to be awakened and respond to a monitoring event. The wakeability score is used by the smart routing mode and by the cloud processor 1040 to inform routing decisions. The scoring pipeline addresses the technical problem of transforming noisy, high-frequency physiological data from wearable sensors into a meaningful, comparable readiness metric suitable for real-time routing decisions.

A wearable device associated with a caregiver, such as a smartwatch, collects heart rate data from a physiological sensor during the sleep period. In certain embodiments, the physiological sensor comprises a photoplethysmography (PPG) sensor that measures blood volume changes through optical sensing. The wearable device samples heart rate data at intervals, such as every several seconds, and transmits the collected data to a companion smartphone application, which in turn transmits the data to the cloud processor 1040 for scoring computation.

The cloud processor 1040 computes a heart rate variability (HRV) metric from the heart rate data. In certain embodiments, the HRV metric is the standard deviation of normal-to-normal inter-beat intervals (SDNN) computed over a recent time window of collected heart rate samples. Higher HRV values indicate deeper, more restorative sleep stages, while lower HRV values indicate lighter sleep or wakefulness. The computation window length may be adjusted based on the number of available samples to ensure statistical reliability.

The cloud processor 1040 normalizes the HRV metric against a baseline value to produce a normalized score. The normalization computes a deviation of the HRV metric from the baseline value relative to a standard deviation associated with the baseline value, producing a standardized score that is comparable across caregivers with different baseline HRV characteristics. This normalization addresses the technical problem that raw HRV values vary significantly between individuals and cannot be directly compared for routing purposes.

The cloud processor 1040 then inverts the normalized score such that a higher HRV, indicative of deeper sleep, produces a lower wakeability score, and a lower HRV, indicative of lighter sleep or wakefulness, produces a higher wakeability score. In one embodiment, the inversion comprises subtracting the product of the normalized score and a scaling factor from a midpoint value. The resulting wakeability score is clamped to a defined range, such as zero to one hundred, where higher values indicate greater readiness to be awakened.

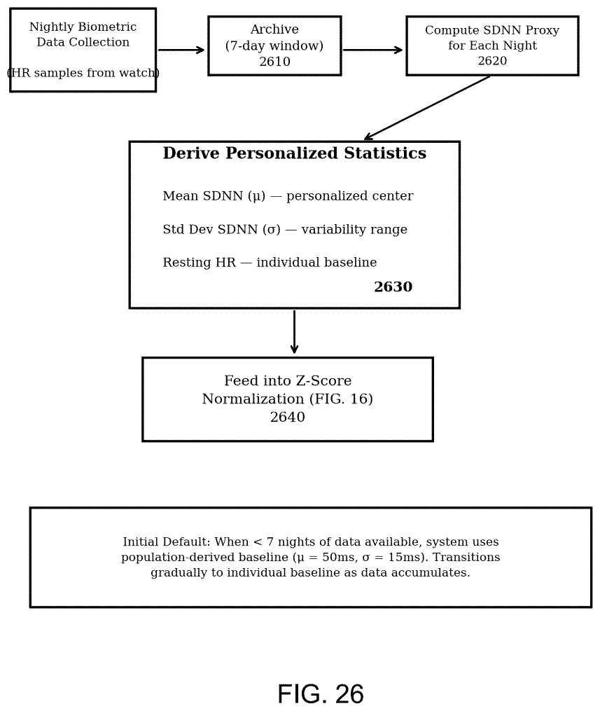

Referring now to FIG. 26, a pipeline diagram illustrates the adaptive baseline computation for heart rate variability normalization. The baseline value used for normalization is adaptively computed from historical HRV data collected from the caregiver over a plurality of prior sleep sessions. The adaptive computation updates the baseline and associated standard deviation as additional sleep sessions are recorded, allowing the system to account for individual physiological variations and changes over time. When insufficient historical data is available, such as during initial use of the system, the baseline value defaults to a population-derived value based on aggregated data from a reference population. In one embodiment, the population-derived baseline HRV is fifty milliseconds with a standard deviation of fifteen milliseconds. As the system collects data from the individual caregiver, the baseline gradually transitions from the population-derived value to the individual-specific value.

The wakeability score may be further adjusted by a motion-based multiplier. The wearable device collects accelerometer data and computes a motion score representing a graded intensity of physical movement. In certain embodiments, the motion score is computed using an accumulation model with an asymmetric response characteristic similar in structure to the audio accumulation model described above: acceleration values exceeding a deviation threshold cause the motion score to increase at a first rate, and acceleration values below the deviation threshold cause the motion score to decrease at a second rate slower than the first rate. The deviation threshold, in one embodiment, is 0.15 times the gravitational acceleration constant. The motion score is applied as a multiplicative factor to the wakeability score, with higher motion scores increasing the wakeability score to reflect that a caregiver exhibiting physical movement is more likely to be in a lighter sleep state or already awake.

The wakeability score may be further adjusted by a heart rate adjustment based on the absolute heart rate value. Higher heart rates during sleep may indicate lighter sleep or physiological arousal, and the heart rate adjustment adds a supplemental value to the wakeability score proportional to the elevation of the current heart rate above a resting baseline.

### Effective Score Computation With Fairness Penalties

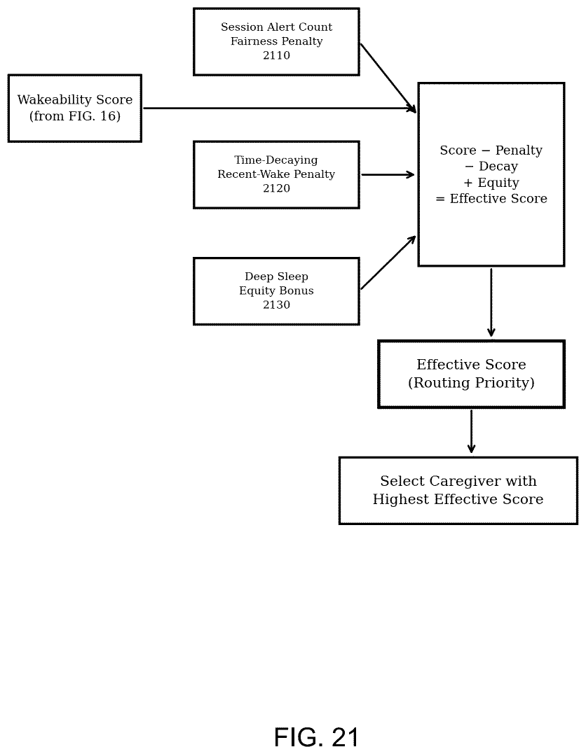

Referring now to FIG. 21, a pipeline diagram illustrates the effective score computation in accordance with various aspects of the subject technology. For each routing decision, the cloud processor 1040 computes an effective score for each caregiver by combining the wakeability score with a fairness penalty, a time-decay adjustment, and a deep sleep equity adjustment. The effective score represents the composite routing priority for the caregiver and is used to select the caregiver with the highest effective score for alert routing.

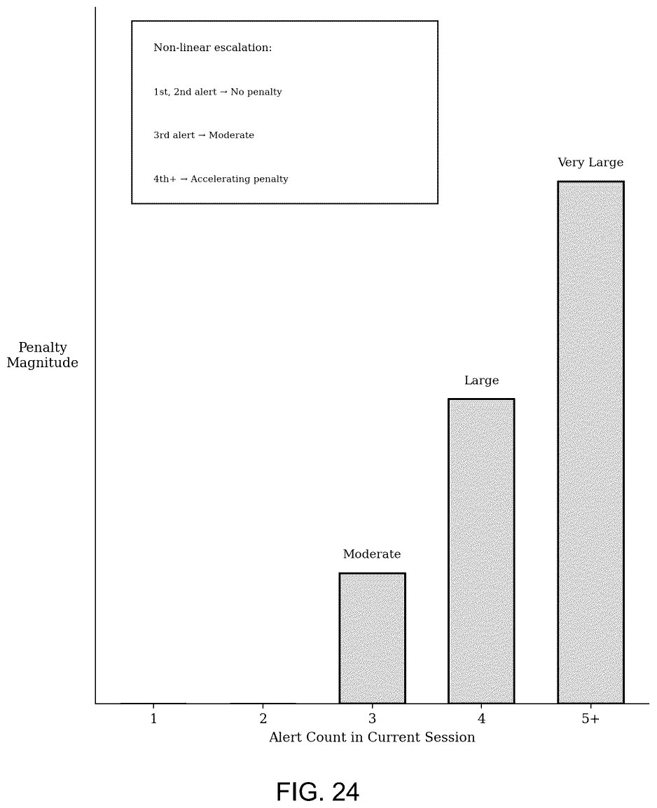

Referring now to FIG. 24, a graph illustrates the non-linear fairness penalty function. The fairness penalty is a non-linear function of the count of alerts previously assigned to the caregiver during the current monitoring period, such as the current night. In one embodiment, the fairness penalty is implemented as a lookup table with entries corresponding to successive alert counts. The magnitude of the penalty increases at an accelerating rate as the alert count increases, such that the first alert assigned to a caregiver incurs no penalty, the second alert incurs no penalty, the third alert incurs a moderate penalty, and subsequent alerts incur progressively larger penalties. This non-linear relationship creates a strong incentive for the system to alternate between caregivers rather than repeatedly assigning alerts to the same caregiver, while permitting limited consecutive assignments when physiological data strongly favors one caregiver.

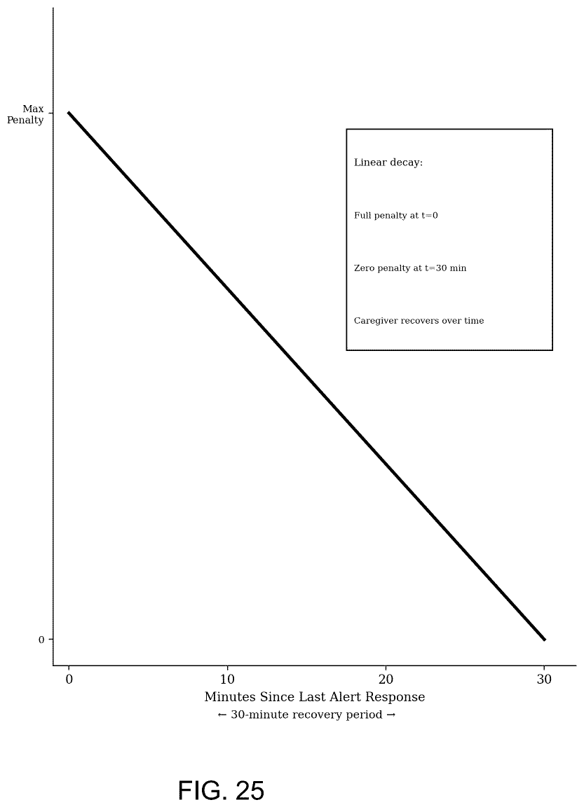

Referring now to FIG. 25, a graph illustrates the time-decaying recent-wake penalty. The time-decay adjustment reduces the magnitude of the fairness penalty as time elapses since the caregiver last responded to an alert. In one embodiment, the time-decay adjustment interpolates linearly from a maximum penalty value to zero over a defined decay period, such as thirty minutes. The time-decay adjustment addresses the situation where a caregiver who responded to an alert earlier in the night has since had substantial additional sleep and should no longer be penalized for the earlier response.

The deep sleep equity adjustment is based on a disparity in cumulative deep sleep duration between the caregivers during the current monitoring period. The system tracks the amount of time each caregiver has spent in deep sleep stages, as estimated from the HRV and motion data. If one caregiver has accumulated substantially less deep sleep than the other, the deep sleep equity adjustment increases the effective score of the better-rested caregiver and decreases the effective score of the less-rested caregiver, promoting equitable distribution of restorative sleep.

In alternative embodiments, the fairness penalty may be implemented as a continuous mathematical function rather than a lookup table, such as a polynomial or exponential function of the alert count. The time-decay adjustment may use non-linear decay curves, such as exponential decay, rather than linear interpolation. The deep sleep equity adjustment may consider additional sleep quality metrics beyond deep sleep duration, such as the number of completed sleep cycles or the total duration of uninterrupted sleep. These alternatives do not limit the scope of the composite scoring approach described above.

In alternative embodiments, the HRV metric used for wakeability scoring may be substituted with related metrics derived from the same photoplethysmogram (PPG) or electrocardiogram (ECG) signal. In certain embodiments, rMSSD (root-mean-square of successive RR interval differences) or pNN50 (percentage of RR intervals differing by more than fifty milliseconds) may be employed instead of SDNN (standard deviation of NN intervals). These alternative HRV metrics capture different aspects of heart rate variability: SDNN measures overall variability, rMSSD emphasizes short-term variability, and pNN50 focuses on extreme variability. In certain embodiments, the system may compute multiple HRV metrics in parallel and apply a weighted aggregation (e.g., wakeability equals 0.5 times score from SDNN plus 0.3 times score from rMSSD plus 0.2 times score from pNN50), providing robustness against metric-specific measurement artifacts. Regardless of which HRV metric or metrics are employed, the inversion property is preserved: higher heart rate variability indicates deeper sleep and lower wakeability.

In certain embodiments, instead of Z-score normalization using a 24-hour adaptive baseline, the system may employ percentile ranking within a historical distribution. In alternative embodiments, the hub maintains a histogram of HRV values recorded over the past 7 days and converts each new measurement to a percentile rank (e.g., current HRV of 50 ms places the wearable at the 75th percentile of its historical distribution). The percentile-based approach is functionally similar to Z-score normalization: both convert raw measurements to position within the wearer's normal distribution, enabling cross-wearer comparison of wakeability despite individual variation in absolute HRV values. In certain embodiments, percentile-based scoring may be preferred in scenarios where the underlying HRV distribution is non-Gaussian, as percentiles are distribution-agnostic.

In alternative embodiments, the motion score component may be applied additively rather than multiplicatively. In certain embodiments, the final wakeability score is computed as: wakeability equals hrv_score plus motion_adjustment, where motion_adjustment is a positive or negative offset rather than a multiplicative factor. In certain embodiments, the additive approach may employ a weighted additive model: wakeability equals 0.7 times hrv_score plus 0.3 times motion_score, where motion_score is independently computed from acceleration metrics. The additive variant is appropriate in scenarios where motion and heart rate variability are weakly correlated, whereas the multiplicative variant is preferred when motion is highly correlated with HRV. Both approaches preserve the semantic property that motion reduces wakeability and that the final score reflects a combination of cardiac and kinetic indicators.

In certain embodiments, the time-decay adjustment may be implemented using exponential decay rather than the linear decay formulation described above. In alternative embodiments, the age-based adjustment factor may be computed as: decay_factor equals exp(-k times age_minutes), where k is a decay constant, such that older measurements are exponentially deweighted rather than linearly deweighted. In certain embodiments, the exponential decay rate may be configurable. In alternative embodiments, the system may employ piecewise decay in which measurements younger than 10 minutes are weighted at full strength, measurements 10-30 minutes old are linearly decayed, and measurements older than 30 minutes are exponentially decayed, providing a combined curve that balances responsiveness and stability.

In alternative embodiments, the deep sleep equity adjustment may be implemented through a per-caregiver or per-session history rather than a global depth counter. In certain embodiments, the system tracks for each caregiver the cumulative deep sleep time they have been routed to during the current day, and adjusts the fairness penalty to prioritize caregivers with lower deep sleep exposure. This per-caregiver fairness variant ensures equitable distribution of wakeups across all caregivers, not just equal alert counts. In certain embodiments, the deep sleep equity adjustment may incorporate weighting by sleep stage confidence score if the wearable's OS provides stage classification APIs (e.g., HealthKit or Health Connect may report sleep stage with associated confidence percentages).

### Multi-Path Alert Delivery With Deduplication

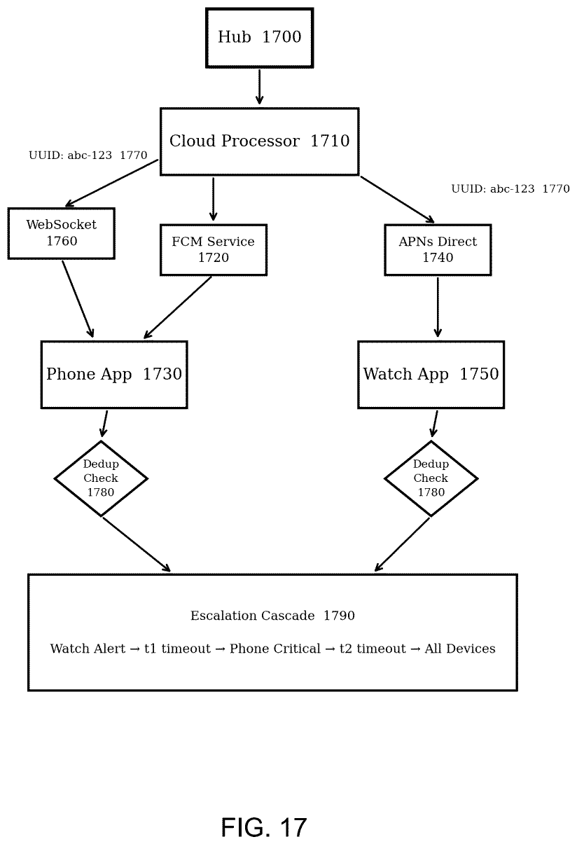

Referring now to FIG. 17, a block diagram illustrates a multi-path alert delivery architecture 1700 with deduplication in accordance with various aspects of the subject technology. The architecture addresses the technical problem of reliable delivery of time-critical alerts to sleeping caregivers across platforms that aggressively manage background application execution.

When the hub device 1100 determines that an alert should be transmitted to a target caregiver, the hub device 1100 generates an alert message comprising a unique alert identifier 1770, such as a universally unique identifier (UUID). The unique alert identifier is included in every transmission of the alert through every delivery path, enabling receiving devices to identify and deduplicate alerts that arrive through multiple paths.

The alert message is transmitted through a plurality of independent delivery paths. A first delivery path comprises the first communication protocol 1050 (e.g., WebSocket over LAN) from the hub device 1100 to the caregiver smartphone 1020. This local path provides the lowest latency delivery when the smartphone application is connected and active. A second delivery path comprises the cloud processor 1040 transmitting the alert via a cloud messaging service 1720, such as Firebase Cloud Messaging (FCM), as a push notification to the mobile application on the caregiver smartphone 1020. A third delivery path comprises the cloud processor 1040 transmitting the alert via a direct connection to a push notification service 1740 of the wearable device platform, such as the Apple Push Notification service (APNs), directed to the companion application on the caregiver wearable device 1030.

The second delivery path and the third delivery path operate through distinct infrastructure and notification services, providing redundancy against platform-specific delivery failures. In certain embodiments, the third delivery path uses a direct HTTP/2 connection from the cloud processor 1040 to the push notification service 1740. The connection is authenticated using a JSON Web Token (JWT) that is refreshed at a predetermined interval, such as every fifty minutes, to comply with token validity requirements imposed by the push notification service. The alert transmitted via the third delivery path carries a time-sensitive interruption level designation that allows the wearable device operating system to present the alert even when the device is in a power-saving state.

Each delivery path operates independently and may deliver the alert at different times. When a caregiver device receives an alert through any delivery path, the device checks the unique alert identifier 1770 against a set of previously received alert identifiers maintained in local memory. If the alert identifier has been previously received, the device suppresses the duplicate presentation. If the alert identifier is new, the device presents the alert and adds the identifier to the set of received identifiers. This deduplication mechanism prevents a caregiver from receiving multiple presentations of the same alert when the alert arrives through multiple paths within a short time window.

The cloud processor 1040 implements a retry mechanism for each delivery path. In certain embodiments, the retry mechanism comprises a plurality of transmission attempts, such as three attempts, with exponentially increasing delay intervals between attempts, such as one second, two seconds, and four seconds. The cloud processor 1040 classifies delivery failures as either permanent or transient. Permanent failures, such as an invalid device token, cause the cloud processor 1040 to schedule asynchronous cleanup of the invalid token to prevent repeated failures on subsequent alerts. Transient failures, such as a server-side error or timeout, cause the cloud processor 1040 to proceed to the next retry attempt.

The system implements a timed escalation cascade 1790. If the alert is transmitted to the caregiver wearable device via the third delivery path and is not acknowledged within a first timeout period, such as ten seconds, the system retransmits the alert to the wearable device. If the alert is still not acknowledged after a second timeout period, such as thirty seconds following the initial transmission, the system transmits a secondary alert to the caregiver smartphone as a fallback, using a notification priority level designated for alerts that should bypass the device silent mode, such as a critical alert. If neither the wearable device nor the smartphone acknowledges the alert within a third timeout period, the system transmits the alert to all registered caregiver devices.

In alternative embodiments, the escalation cascade may include additional notification channels. For example, the system may interface with smart home devices, such as smart speakers or smart lights, to provide audible or visual alerts in the caregiver bedroom. The system may transmit alerts to designated emergency contacts via messaging services. The cascade may be configurable by the caregiver, allowing selection of preferred escalation paths and timeout values. These alternatives do not limit the scope of the multi-path delivery architecture with deduplication described above.

In alternative embodiments, additional alert delivery channels may be integrated beyond WebSocket/LAN, FCM, and APNs. In certain embodiments, SMS (Short Message Service) may serve as a fallback delivery path for scenarios in which both FCM and APNs are unavailable. In such embodiments, the hub initiates SMS delivery by obtaining the caregiver's phone number from the device registration record, formatting an alert message with cry session ID and urgency level, and transmitting via an SMS gateway service authenticated with API credentials stored on the hub. In certain embodiments, SMS delivery may include a reply instruction enabling the caregiver to acknowledge via SMS, which the hub processes through SMS inbound webhook callbacks. In alternative embodiments, email delivery may be substituted for or combined with SMS, with the understanding that email provides lower latency guarantees than SMS and is more suitable for informational alerts rather than real-time cry detection.

In certain embodiments, smart home ecosystem integrations may serve as alert delivery channels. In alternative embodiments, if a caregiver has enabled integration with Amazon Alexa or Apple HomeKit, the hub may deliver alerts by invoking smart home APIs to speak an alert message through the caregiver's HomePod or Echo device. In certain embodiments, the hub maintains a configuration store mapping caregivers to their associated smart home devices and uses OAuth2 tokens to authenticate with smart home APIs. The caregiver may respond to the spoken alert by speaking a voice command, which the smart home system relays back to the hub via webhook or polling. This smart home integration path is complementary to mobile-based delivery and provides an alternative for caregivers who may not have their smartphone nearby but are in a room with a smart home speaker.

In alternative embodiments, the UUID-based deduplication mechanism may be supplemented or replaced with timestamp-based deduplication. In certain embodiments, each alert is tagged with a server-side timestamp, and the client-side deduplication logic compares timestamps to determine if an alert is a duplicate. However, the UUID mechanism provides stronger deduplication guarantees in scenarios with clock skew between hub and clients, so both mechanisms may be employed concurrently.

In certain embodiments, the retry logic with exponential backoff may be enhanced with jitter to prevent thundering herd effects. In alternative embodiments, instead of strictly doubling the backoff interval, the hub may randomize the interval within an exponential window, distributing retry attempts across time and reducing peak load on the alert delivery infrastructure. In alternative embodiments, the backoff strategy may be adaptive based on cloud service response patterns.

In alternative embodiments, the timed escalation cascade may implement soft escalation in addition to hard escalation. In certain embodiments, the cascade is: initial send to wearable via WebSocket/LAN at t=0, soft escalation to smartphone app via FCM at t=10 s, hard escalation to all caregivers broadcast at t=30 s. The soft escalation adds additional paths without releasing the primary caregiver lock, whereas hard escalation both adds paths and releases mode/caregiver locks. In certain embodiments, the escalation logic may be configurable per caregiver.

### Multi-Layer Reliability Architecture for Continuous Overnight Monitoring

Referring now to FIG. 13, a layered diagram illustrates a multi-layer reliability architecture 1800 for continuous overnight monitoring in accordance with various aspects of the subject technology. The architecture addresses the technical problem of maintaining continuous physiological data collection and alert delivery capability across devices that operate under aggressive power management policies for extended periods, such as eight or more hours.

The reliability architecture comprises five functional layers, each addressing distinct failure modes that can interrupt monitoring during extended sleep sessions. The layers operate concurrently and independently, providing defense-in-depth against the cumulative set of failure modes.

A first layer 1810 comprises phone background persistence mechanisms. Mobile operating systems terminate background applications that do not maintain recognized activity indicators. The first layer maintains a plurality of concurrent background persistence mechanisms on the companion mobile device. In certain embodiments, the mechanisms comprise: a silent audio session 1811 that maintains an active audio playback session using an inaudible audio track, preventing the operating system from classifying the application as idle; a background location session 1812 that maintains location services activity, qualifying the application for continuous background execution privileges; a state restoration protocol 1813 for the short-range radio communication stack that enables the operating system to relaunch the application and restore active connections upon application termination; and periodic background refresh tasks 1814 scheduled with the operating system task scheduler to execute the application at regular intervals.

A second layer 1820 comprises wearable device background persistence mechanisms. Wearable operating systems impose time-limited background execution sessions that expire after a defined period. The second layer maintains continuous execution on the wearable device through: an extended runtime session 1821 that requests additional background execution time from the wearable operating system, with automatic restart upon expiration such that the session is renewed indefinitely throughout the monitoring period; a persistent monitoring state 1822 stored in non-volatile storage on the wearable device, enabling the companion application to resume monitoring state upon relaunch without user intervention; and background refresh scheduling 1823 that registers the application for periodic execution opportunities provided by the operating system.

The persistent monitoring state 1822 comprises at least a session start time, a current alert routing mode, a hub device identifier, and a connection state. The persistent monitoring state is stored to non-volatile storage upon each state transition and is read upon application launch. A maximum age limit, such as twenty-four hours, is applied to the persistent state, beyond which the state is discarded as stale and a fresh monitoring session must be initiated. This age limit prevents the system from resuming into an outdated state after extended device inactivity.

A third layer 1830 comprises health data watchdog mechanisms. Even with background execution maintained, the physiological sensor on the wearable device may stop delivering data due to sensor hardware interruptions, changes in skin contact, or operating system resource constraints. The third layer detects and recovers from data delivery interruptions through: a heart rate staleness monitor 1831 that tracks the time elapsed since the most recent heart rate sample was received from the physiological sensor, and upon detecting that no data has been received within a staleness threshold, such as one hundred eighty seconds, terminates and reinitializes the health monitoring session to restart data collection; a session auto-restart mechanism 1832 that reinitializes the health monitoring session without limit on the number of consecutive restarts, ensuring persistent recovery from repeated sensor interruptions; and a phone heartbeat ping mechanism 1833 comprising periodic signals transmitted from the companion mobile device to the wearable device at a defined interval, such as every one hundred eighty seconds, serving as an external liveness check that triggers session restart if the wearable device detects loss of the heartbeat signal.

In certain embodiments, the health monitoring session on the wearable device is implemented using an exercise session interface provided by the wearable operating system. The exercise session interface provides sustained access to the physiological sensor at higher sampling rates than are available during normal background execution. The watchdog mechanism restarts this exercise session interface upon detecting data staleness, re-establishing the higher-rate sensor access.

A fourth layer 1840 comprises alert delivery redundancy mechanisms, as described in the section titled Multi-Path Alert Delivery with Deduplication above. This layer ensures that even if one or more delivery paths fail due to network conditions, platform throttling, or application state, the alert reaches the caregiver through an alternative path.

A fifth layer 1850 comprises a cloud safety net. The cloud processor 1040 monitors the timestamp of the most recent physiological data received from each wearable device. Upon determining that the timestamp exceeds a cloud-side staleness threshold, such as a duration substantially longer than the expected reporting interval, the cloud processor 1040 transmits a wake signal to the companion mobile device. The wake signal triggers reinitialization of the health monitoring session on the wearable device via the companion mobile device, providing an external recovery mechanism for cases where the on-device watchdog mechanisms have also failed.

In alternative embodiments, individual layers may be omitted or replaced with functionally equivalent mechanisms appropriate to different operating system platforms. For example, a wearable device operating system that does not provide extended runtime sessions may use a complication or widget-based background execution mechanism instead. A mobile operating system that does not support background audio sessions may use a persistent notification or foreground service mechanism. The specific mechanisms within each layer are adaptable to the capabilities and constraints of the target platform, while the multi-layer architecture ensures that the overall system maintains monitoring continuity regardless of individual mechanism availability.

In alternative embodiments, phone persistence may be augmented with additional background capabilities beyond silent audio, location, and state restoration. In certain embodiments, the phone app may employ foreground service (Android) or high-priority background processing to maintain a persistent alert monitoring thread even when the app is not visibly in the foreground. On Android, a persistent foreground service displays a non-dismissible notification indicating that cry detection monitoring is active, satisfying OS transparency requirements while allowing the app to execute critical code even when the user has switched to other apps. In certain embodiments, the foreground service may implement a periodic heartbeat in which the app re-registers with the hub, ensuring that the hub recognizes the app as available even if the OS suspends background execution. In alternative embodiments, the app may register with the OS work scheduler (Android JobScheduler, iOS BackgroundTasks) to request periodic wake-ups from the OS at intervals during which the app briefly connects to the hub and synchronizes state.

In certain embodiments, wearable persistence may be enhanced through integration with native wearable OS capabilities. In alternative embodiments, the wearable app may directly invoke HealthKit APIs (iOS) or Health Connect APIs (Android) to request long-lived access to biometric events, allowing the OS to wake the wearable app upon significant HRV changes even if the app has not been explicitly launched. In certain embodiments, the wearable may register a complication (watchOS) or tile (Wear OS) that displays alert status or cry detection confidence. In alternative embodiments, the wearable may integrate with native smartwatch alert mechanisms such that alerts are displayed via the wearable OS's native UI rather than a custom app UI, reducing battery overhead.

In alternative embodiments, the health watchdog layer may implement not only staleness monitoring and auto-restart, but also graceful degradation modes. In certain embodiments, if the hub detects that the phone app is stale, the hub may transition to a reduced-frequency monitoring mode: instead of processing every audio sample in real-time, the hub records audio to local storage and processes it in batch at intervals, reducing power consumption while maintaining reasonable alert latency. In certain embodiments, the health watchdog may also monitor wearable connectivity and automatically adjust motion detection sensitivity if wearable connectivity is poor. This graceful degradation ensures that the system maintains baseline functionality even if some components are partially unavailable.

In certain embodiments, alert delivery redundancy may extend beyond the three paths (WebSocket/LAN, FCM, APNs) to include additional fallback mechanisms. In alternative embodiments, the hub may maintain a cache of caregivers' email addresses and phone numbers, and if both FCM and APNs delivery attempts fail after maximum retries, the hub may escalate to email or SMS delivery as an ultimate fallback. In certain embodiments, the hub may also log all alert delivery attempts to a local database, enabling asynchronous retry logic. In alternative embodiments, the hub may implement a delivery ticket system in which each alert is assigned a unique ticket ID, and caregivers' apps periodically query the hub for pending tickets, implementing a poll-based redundancy mechanism complementary to push-based delivery.

In alternative embodiments, the exercise session interface may be extended to distinguish between different types of activity and adjust alert routing accordingly. In certain embodiments, the wearable may provide not only a binary exercise flag but also a confidence score indicating likelihood of active exercise. The hub may weight the exercise suppression logic by confidence. In certain embodiments, the exercise session interface may include activity type hints (running, walking, strength training), allowing the hub to apply activity-specific routing policies.

In certain embodiments, persistent state with max age constraints may be implemented through cryptographic timestamping rather than wallclock timestamps. In alternative embodiments, each persistent state item may be signed with a timestamp and the hub's private key. When state is retrieved from storage, the hub verifies the signature and checks that the timestamp is not older than max age; if verification fails or age exceeds max age, the state is treated as invalid and re-fetched or recomputed. This cryptographic approach prevents tampering with persisted state by external processes and provides non-repudiation.

### Proximity-Based Alert Suppression Using Signal Strength Analysis

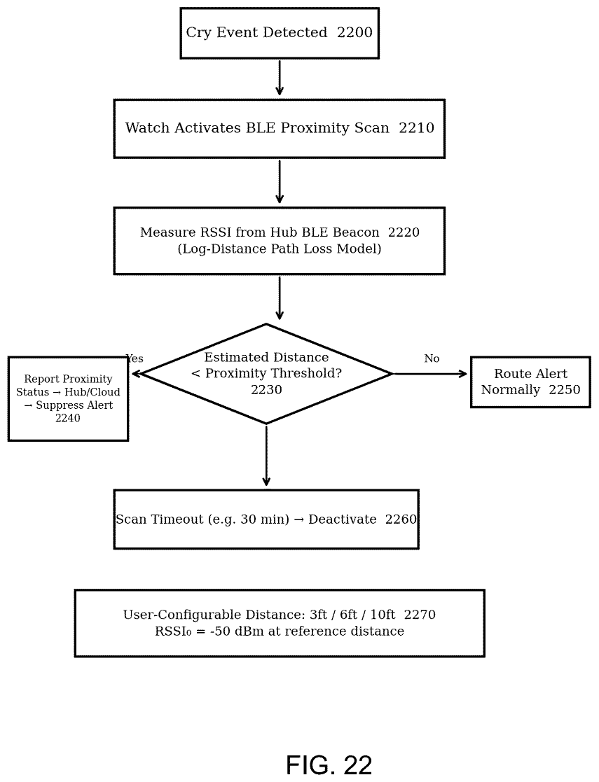

Referring now to FIG. 22, a diagram illustrates BLE proximity detection and alert suppression using received signal strength analysis in accordance with various aspects of the subject technology. In certain embodiments, the system suppresses alerts directed to a caregiver who is already in physical proximity to the monitored subject, on the basis that a caregiver who is already present does not require a remote notification. The proximity determination uses signal strength analysis of the short-range wireless signals transmitted by the hub device 1100.

The hub device 1100, via the third communication protocol 1130, transmits wireless advertisement signals at a defined advertising interval. The wearable device 1030 associated with a caregiver receives the advertisement signals and measures a received signal strength indicator (RSSI) value for each received signal.

The wearable device 1030 computes an estimated distance between the wearable device 1030 and the hub device 1100 using a log-distance path loss model applied to the RSSI value. In certain embodiments, the path loss model uses the relationship: RSSI equals a reference signal strength value plus a factor proportional to the logarithm of the ratio of the estimated distance to a known reference distance. The reference signal strength value is calibrated at the known reference distance, such as a signal strength of negative fifty decibels-milliwatt (dBm) measured at a reference distance of three feet. The proportionality factor accounts for the signal attenuation characteristics of the indoor environment.

The wearable device 1030 compares the estimated distance to a configurable proximity threshold. The configurable proximity threshold is derived from a user-selected distance preference stored in the system configuration. In certain embodiments, the user may select from a set of predefined distance options, such as three feet, six feet, or ten feet, and the system computes the corresponding RSSI threshold using the path loss model.

Upon determining that the estimated distance is less than the configurable proximity threshold, the wearable device 1030 transmits a proximity status to the hub device 1100 or the cloud processor 1040. The proximity status is periodically reported at a defined reporting interval, such as every ten seconds, during an active monitoring event. The hub device 1100 or cloud processor 1040 uses the proximity status as an input to the routing decision, suppressing alerts directed to the caregiver on the basis that the caregiver is already near the monitored subject.

Proximity scanning on the wearable device 1030 is activated upon detection of an event associated with the monitored subject and is deactivated after a predetermined maximum scanning duration, such as thirty minutes, to conserve battery power on the wearable device. The scanning duration is bounded to prevent sustained battery drain in cases where the caregiver remains in proximity for an extended period.

In alternative embodiments, proximity detection may use alternative signal processing techniques, such as averaging multiple RSSI readings over a sliding window to reduce the effect of multipath fading, or applying Kalman filtering to produce smoother distance estimates. The proximity threshold may be adaptively adjusted based on historical signal strength measurements in the specific environment. These alternatives do not limit the scope of the path loss model approach described above.

In alternative embodiments, the RSSI-based proximity model may be augmented or replaced with additional radio measurement techniques. In certain embodiments, Bluetooth 5.1 Direction Finding (AoA/AoD) may provide angular information in addition to distance estimates. In alternative embodiments, WiFi RTT (round-trip time) may be employed if the wearable includes WiFi capability, providing more accurate distance estimates than BLE RSSI. In certain embodiments, UWB (Ultra-Wideband) ranging may offer the highest accuracy at the expense of increased power consumption. The hub may employ a hybrid approach in which UWB is preferred when available and power budget permits, WiFi RTT is used if UWB is unavailable, and RSSI falls back as the lowest-accuracy option.

In certain embodiments, the proximity threshold may be contextualized based on location or activity type. In alternative embodiments, instead of a fixed proximity threshold, the hub may maintain a configuration table specifying threshold per room or zone. The hub may estimate room location through WiFi AP association or through additional BLE beacons placed in different rooms. In certain embodiments, the proximity threshold may also vary by time-of-day or activity state.

In alternative embodiments, periodic proximity reporting may be supplemented with event-triggered proximity reporting. In certain embodiments, the wearable reports RSSI distance only when the distance changes by more than a threshold or when the proximity state transitions. This event-triggered approach reduces reporting frequency while maintaining sufficient accuracy for suppression decisions.

In certain embodiments, proximity suppression may incorporate not full suppression but partial suppression via prioritization. In alternative embodiments, a tiered proximity approach may implement multiple suppression thresholds: strict suppression if caregiver is within 3 meters, soft suppression (deliver only high-intensity alerts) if within 3-10 meters, and no suppression if beyond 10 meters.

In alternative embodiments, proximity detection may be augmented with additional sensor modalities. In certain embodiments, the hub may include a PIR (passive infrared) motion sensor that detects human presence in the same room, and the hub may automatically suppress alerts if motion is detected in the room containing the baby monitor. In alternative embodiments, the hub may incorporate an acoustic presence detector that listens for human speech or footsteps in the monitored environment. In certain embodiments, the hub may also support NFC-based suppression wherein the caregiver taps an NFC tag on or near the baby monitor to explicitly mark themselves as present and suppress alerts temporarily.

### Safety-Gated Firmware Update Mechanism

Referring now to FIG. 14, a flow diagram illustrates a safety-gated firmware update method 1900 in accordance with various aspects of the subject technology. The method addresses the technical problem of safely updating firmware on a hub device that operates continuously during safety-relevant monitoring periods.

The hub device 1100 receives an indication that a firmware update is available 1900, such as a flag included in a response to a periodic heartbeat message sent from the hub device 1100 to the cloud processor 1040. The indication may include a download URL, a firmware version number, a mandatory flag, and a rollout percentage.

The hub device 1100 first evaluates whether the update is designated as mandatory 1910. A mandatory update may address a safety-critical defect or a security vulnerability that must be applied regardless of the device state. If the update is mandatory, the hub device 1100 proceeds to execute the firmware update 1950 without further state evaluation.

If the update is not mandatory, the hub device 1100 evaluates whether the device is in an idle state. The idle state evaluation comprises determining whether any caregiver devices are connected to the hub device 1100 via the first communication protocol 1920, and determining whether an active monitoring session is in progress 1930, as indicated by a non-zero session timer. If any caregiver devices are connected or a monitoring session is active, the hub device 1100 defers the update 1940 and re-evaluates the idle state at a subsequent heartbeat interval 1941. This gating prevents the firmware update from interrupting active monitoring, which would cause a temporary loss of event detection and alert delivery capability.

If the device is in the idle state, the hub device 1100 further evaluates whether it is included in the current rollout group 1935. The rollout group evaluation computes a hash of a device identifier of the hub device 1100, such as the MAC address, and compares the hash value modulo one hundred to the rollout percentage threshold. If the hash falls within the rollout percentage, the device is in the current rollout group and proceeds to execute the update 1950. If the hash does not fall within the rollout percentage, the device defers the update 1940. This mechanism enables gradual deployment of firmware updates across a fleet of hub devices, allowing identification and remediation of defects before full deployment.

In alternative embodiments, the idle state evaluation may include additional conditions, such as verifying that the hub device 1100 has a stable power supply, that the battery level exceeds a minimum threshold, or that the network connection has been stable for a minimum duration. The rollout mechanism may use alternative distribution functions beyond hash-based grouping. These alternatives do not limit the scope of the safety-gated update mechanism described above.

In alternative embodiments, the idle state check for OTA updates may be relaxed to allow updates during specific safe operating states beyond complete idleness. In certain embodiments, if the hub is in a state where no cry session is currently active, the hub has not detected a cry event in the past 10 minutes, and the hub is connected to AC power, the hub may initiate OTA update even if other network connections are present. In alternative embodiments, the system may implement update deferral logic: if the hub detects an incoming cry event while an update is in progress, the update is immediately paused, the alert is processed, and the update resumes only after the cry session ends. This allows updates to proceed during low-activity periods while always prioritizing alert handling.

In certain embodiments, the hash-based rollout grouping may be supplemented with additional distribution strategies. In alternative embodiments, the system may use time-based rollout phases: all devices in group 0-20 receive updates on Day 1, groups 20-40 on Day 2, and groups 40-100 on Day 3. This staggered rollout reduces load on cloud infrastructure and allows for staged validation. In certain embodiments, the rollout grouping may be weighted by device age or software version.

In alternative embodiments, the mandatory override mechanism may be implemented as a two-factor authentication challenge. In certain embodiments, a caregiver with administrative privileges must enter a PIN or biometric authentication and confirm the update on a second registered admin device. In certain embodiments, the override may be rate-limited to prevent excessive OTA cycles. In alternative embodiments, the override may include an audit log entry.

In certain embodiments, the OTA mechanism may employ A/B partition updates wherein new firmware is written to an inactive partition while the active partition continues running. In alternative embodiments, once the new firmware is successfully validated, the hub atomically switches the active partition pointer to the new firmware on the next reboot. If the new firmware fails validation, the hub reverts to the original partition without requiring a manual rollback procedure. This A/B approach eliminates the need for idle state detection: the update may be performed anytime since the active system is not interrupted. In certain embodiments, the hub may incorporate a watchdog timer that monitors the new firmware after partition switch; if the watchdog detects system instability within the first 30 seconds, it automatically reverts to the previous partition.

In alternative embodiments, instead of monolithic firmware updates, the hub may employ a modular update architecture in which only changed components are updated. In certain embodiments, the hub may segment firmware into modules (cry detection engine, cloud communication stack, alert routing logic, BLE radio driver) and update only the modules with changes. This delta-based approach reduces update payload size, accelerates update download/installation, and reduces risk of unrelated regressions. In certain embodiments, each module may have its own version number and rollout group. In alternative embodiments, the system may employ containerized or sandboxed module updates wherein each module runs in isolation with defined interfaces, preventing a faulty module update from cascading failures to other systems.

### Cloud-First Routing Architecture with Local Fallback

Referring now to FIG. 15, a block diagram illustrates a cloud-first routing architecture with local fallback capability in accordance with various aspects of the subject technology. The architecture prioritizes cloud-based routing decisions while maintaining the ability to operate independently when cloud connectivity is unavailable.

During normal operation, the hub device 1100 transmits event data to the cloud processor 1040, which applies the wakeability scoring pipeline and effective score computation described above to determine the optimal target caregiver. The cloud processor 1040 returns a routing decision to the hub device 1100, which then executes the alert delivery through the multi-path architecture described above.

When the hub device 1100 detects that the cloud processor 1040 is unreachable, as determined by a failed authenticated request or a connection timeout, the hub device 1100 transitions to a local routing mode. In local routing mode, the hub device 1100 uses the most recently cached wakeability scores for each caregiver to make the routing decision. The cached scores are updated each time the cloud processor 1040 successfully responds to a routing request, ensuring that the cached values reflect the most recent cloud-computed scores.

The hub device 1100 periodically attempts to restore the connection to the cloud processor 1040 during local routing mode. Upon successful reconnection, the hub device 1100 resumes cloud-first routing for subsequent events and updates the cached wakeability scores.

### Additional Embodiments and Variations

The systems and methods described herein may be combined in various configurations without departing from the scope of the disclosure. The following additional embodiments provide further illustration of the breadth of the disclosed concepts.

In certain embodiments, the hub device 1100 may be integrated into an existing consumer electronic device, such as a smart speaker, a smart display, or a wireless access point. The integrated device provides the processor 1101, audio sensor 1110, and communication interfaces described herein as additional capabilities of the host device. This integration reduces the number of devices required in the monitoring environment and leverages existing hardware and power infrastructure.

In certain embodiments, the system may support more than two caregivers. The routing modes described herein, including smart, alternating, schedule, and broadcast modes, may be extended to accommodate three or more caregivers. The alternating mode may cycle through all registered caregivers in sequence. The schedule mode may partition the monitoring period into more than two shifts. The smart mode may compute wakeability scores and effective scores for all registered caregivers and select the caregiver with the highest effective score. The fairness penalties and deep sleep equity adjustments described herein apply across all registered caregivers.

In certain embodiments, the audio sensor 1110 may be supplemented or replaced by other sensor modalities. For example, a video camera with motion detection may identify visual indicators of subject distress, such as sustained body movement or position changes. A temperature sensor may detect changes in the subject environment that correlate with subject discomfort. A wearable sensor attached to the subject may provide direct physiological measurements, such as heart rate, blood oxygen saturation, or respiratory rate. The event detection and session management mechanisms described herein apply regardless of the sensor modality used to detect the triggering event.

In certain embodiments, the wakeability scoring pipeline may incorporate additional physiological inputs beyond heart rate variability, motion, and heart rate. For example, respiratory rate variability, skin temperature, blood oxygen saturation, or electrodermal activity may provide additional indicators of sleep depth and readiness. The normalization, inversion, and composite scoring approaches described herein may be applied to any physiological metric that correlates with sleep state.

In certain embodiments, the system may operate without a dedicated hub device. The functions of the hub device 1100, including audio sensing, event detection, session management, and alert routing, may be distributed across the caregiver smartphones and cloud processor. For example, one caregiver smartphone positioned near the monitored subject may perform audio sensing and event detection, while the cloud processor performs routing decisions and alert delivery. In such embodiments, the session management and routing mode logic described herein are executed on the cloud processor or on a designated caregiver smartphone rather than on a dedicated hub device.

In certain embodiments, the multi-path alert delivery architecture may be adapted for platforms other than those specifically described. For example, Android-based wearable devices may receive alerts through the Google Cloud Messaging or Firebase Cloud Messaging services rather than APNs. Other wearable platforms may use platform-specific notification services. The deduplication mechanism using unique alert identifiers and the timed escalation cascade are platform-independent and may be applied across any combination of notification services and device types.

In certain embodiments, the asymmetric accumulation model may be applied to sensor modalities other than audio. For example, the accumulation model may be applied to motion sensor data to detect sustained movement events, to temperature sensor data to detect sustained temperature deviations, or to physiological sensor data to detect sustained vital sign anomalies. The asymmetric fill and drain rates, configurable threshold, and trigger level mechanisms described herein are applicable to any time-series sensor data where discrimination between transient fluctuations and sustained events is desired.

In certain embodiments, the overnight reliability architecture may be adapted for different operating system platforms and their specific background execution policies. The multi-layer approach, in which independent mechanisms at the phone layer, wearable layer, data watchdog layer, delivery layer, and cloud layer each address distinct failure modes, is applicable regardless of the specific mechanisms available on any particular platform. The principle of defense-in-depth, wherein no single layer is relied upon exclusively for monitoring continuity, applies across all platform configurations.

In alternative embodiments, the Dozzi baby monitor system may employ a fully decentralized architecture in which all devices (hub, phones, wearables) are peers and collectively maintain the caregiver roster, session state, and routing decisions through a consensus protocol. In certain embodiments, each device may maintain a copy of the current caregiver list and session state, and when a cry event occurs, devices use a Byzantine Fault Tolerant (BFT) consensus mechanism to agree on the target caregiver. However, in most deployments, the centralized hub-based architecture described in the main specification is preferred, as it simplifies state management, reduces computation on battery-constrained wearables, and provides a single source of truth for device registration and caregiver roles.

In certain embodiments, the system may support hybrid cloud-local deployments wherein the hub maintains bidirectional synchronization with a cloud backend. In alternative embodiments, caregivers may configure sync policies specifying what data is synced to cloud: a privacy-focused caregiver may specify that only metadata is synced, while all audio and biometric data remains local. In certain embodiments, the hub may implement conflict resolution logic for scenarios where cloud and local state diverge.

In alternative embodiments, the system may support integration with third-party baby monitoring platforms or wearable ecosystems. In certain embodiments, the cry detection and routing logic may be implemented as a software module that integrates with existing smartwatch platforms (Wear OS, watchOS, Samsung Galaxy Wearables). The module would interface with the native health APIs on those platforms to access heart rate data, and would implement the same wakeability scoring and caregiver routing logic. In alternative embodiments, the hub logic may be implemented as a service running on commodity smartphones without requiring a dedicated hub device.

In certain embodiments, the system may incorporate machine learning and online adaptation to improve alert routing performance over time. In alternative embodiments, after each cry session, the hub may record a feature vector including cry intensity, time-of-day, caregiver response latency, and acknowledgment time and store in a local training buffer. Periodically, the hub may retrain a local decision model, optimizing for objectives such as minimizing response latency or maximizing fairness. In certain embodiments, the hub may also accept feedback from caregivers and incorporate this feedback into the decision model.

In alternative embodiments, the system may extend beyond cry detection to broader infant monitoring, including monitoring for other alarm conditions such as SIDS risk detection via respiration rate anomalies, abnormal sleep positions via actigraphy analysis, or fever via temperature sensors. In certain embodiments, each alarm condition maintains its own session state machine and follows the same multi-path alert delivery infrastructure. In alternative embodiments, the system may implement alarm aggregation: if multiple alarm conditions trigger simultaneously, the hub may escalate directly to broadcast mode.

In certain embodiments, the system may support integration with professional monitoring services. In alternative embodiments, a caregiver may configure a professional escalation policy specifying that if no registered family caregiver acknowledges within a specified timeout, the alert automatically escalates to a professional monitoring service. In certain embodiments, the professional monitoring service may receive cry audio recordings and wakeability scores to inform their triage decisions.

### Distinctions From Conventional Systems

The following paragraphs describe characteristics of the present disclosure that distinguish it from conventional monitoring and alerting systems. These descriptions are provided to clarify the scope of the invention and to explicitly identify features that the system of the present disclosure avoids or does not require.

The present disclosure does not require simultaneous alerting of all caregivers for every detected event. Instead, the system of the present disclosure selectively routes alerts to a single designated target caregiver while permitting other caregivers to continue sleeping undisturbed, thereby preserving sleep quality and availability across the caregiving team.

Unlike conventional systems that depend entirely on cloud connectivity, the system of the present disclosure does not require continuous cloud connectivity for operational monitoring. The hub device maintains local alert routing capability using cached state data, including caregiver physiological profiles and recent wakeability computations, enabling continued alert generation and routing even when cloud servers are temporarily unreachable.

The system of the present disclosure does not transmit raw biometric data to unauthorized third parties or permit uncontrolled access to physiological information. Instead, physiological data is processed locally within the monitoring device or through authenticated channels with encryption, ensuring that caregiver biometric information remains private and confidential.

The present disclosure does not require manual intervention to maintain monitoring continuity overnight or to manage transitions between caregivers. The multi-layer reliability architecture of the present disclosure automatically detects component failures, recovers from transient connection losses, and maintains alert routing capability across extended monitoring sessions without human action.

The system of the present disclosure does not require a specific hardware platform or dedicated proprietary device. The disclosed methods are implementable on general-purpose processors, smartphones and tablets, dedicated embedded devices designed for monitoring, smart speakers and voice assistants, and edge computing appliances, enabling deployment across diverse hardware ecosystems.

Unlike single-path alerting systems, the present disclosure does not rely on a single communication channel for alert delivery. Instead, the system employs redundant parallel delivery paths including local network connections, push notification services, direct HTTP connections to caregiver devices, and additional fallback mechanisms, with deduplication logic to prevent alert duplication.

### Functional Elements and Corresponding Structure

The following paragraphs identify specific structural implementations corresponding to functional elements described in this specification and the appended claims. These descriptions are provided to satisfy the requirements of 35 U.S.C. § 112 and to ensure that the scope of each functional limitation is understood in light of the specific structures, materials, and acts disclosed herein.

In the context of the present disclosure, the function of detecting an event associated with the monitored subject is performed by the audio sensor 1802 (a MEMS microphone) coupled to the hub processor 1801 via an I2S digital audio interface, executing the asymmetric accumulation model with configurable rising and falling thresholds, or alternatively executing a machine learning classifier trained on acoustic event signatures, or executing spectral analysis algorithms to identify frequency content characteristic of infant crying. The corresponding structure is further illustrated in FIG. 15, which depicts the signal flow from the MEMS microphone through preprocessing, feature extraction, and event classification stages.

In the context of the present disclosure, the function of computing a wakeability score is performed by the cloud processor 1840 executing the wakeability scoring pipeline comprising heart rate variability (HRV) computation from caregiver device sensor data, Z-score normalization of HRV and motion metrics relative to baseline distributions, inversion to convert metrics into a sleep-depth score, and motion-based adjustment to reflect recent activity patterns. Alternatively, the hub device processor 1801 may execute a local wakeability scoring algorithm using cached caregiver physiological data when cloud connectivity is unavailable, performing the same computational steps with data stored in local memory.

In the context of the present disclosure, the function of transmitting alerts to caregiver devices is performed by the multi-path alert delivery architecture 2100 comprising a first path utilizing WebSocket protocol over local area network connections to wearable devices, a second path utilizing FCM (Firebase Cloud Messaging) push notifications to Android smartphones, a third path utilizing APNs (Apple Push Notification service) direct HTTP/2 connections to iOS devices, and an escalation cascade logic that attempts delivery via each path in sequence until successful delivery is confirmed. The corresponding structure is depicted in FIG. 17, showing the alert transmission routing logic and deduplication mechanisms.

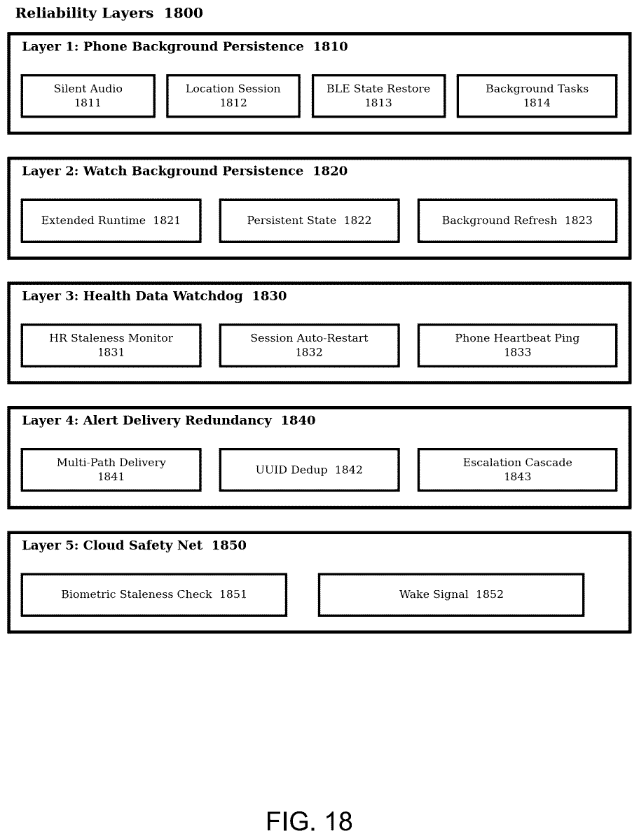

In the context of the present disclosure, the function of maintaining background execution and ensuring continuous monitoring despite system-level power management and application lifecycle constraints is performed by the multi-layer reliability architecture 2200 comprising phone persistence mechanisms including silent audio session maintenance, background location updates, and state restoration protocols; wearable persistence mechanisms including extended background task runtime sessions, persistent monitoring state flags, and background refresh scheduling; and health data watchdog mechanisms that monitor the integrity of sensor data streams and trigger recovery actions upon detection of discontinuities. The corresponding structure is illustrated in FIG. 18, showing the layered architecture for maintaining monitoring continuity.

In the context of the present disclosure, the function of determining proximity between a caregiver wearing a wearable device and the monitored subject near the hub device is performed by the wearable device 1860 receiving BLE advertisement signals transmitted by the hub device 1800, computing an estimated distance from the monitored subject by applying the log-distance path loss model to received signal strength indication (RSSI) values, and comparing the computed distance to a configurable proximity threshold. Alternatively, proximity determination may be accomplished via Wi-Fi round-trip time (RTT) measurements, ultra-wideband (UWB) ranging techniques, or angle-of-arrival (AoA) estimation, each providing corresponding structure for the proximity determination function.

### Computer-Readable Media Implementations

The methods and systems described herein may be embodied as instructions stored on a non-transitory computer-readable storage medium or computer-readable medium. Such storage media include flash memory, read-only memory (ROM), random-access memory (RAM), magnetic disk drives, optical disk drives, solid-state storage devices, erasable programmable read-only memory (EPROM), electrically erasable programmable read-only memory (EEPROM), and any other tangible medium capable of storing digital data persistently or temporarily.

When executed by a processor, such as a processor of the hub device, a smartphone or tablet caregiver device, a server computer, a cloud computing service, or a wearable device, the instructions stored on the non-transitory computer-readable medium cause the processor to perform the methods of event detection from sensor data, alert routing and caregiver selection, monitoring session management, and multi-path alert delivery with deduplication, as disclosed herein.

The instructions embodying the present disclosure may be distributed across multiple devices and computing nodes, with portions of the instructions executing on the hub device to perform local event detection and caching, portions executing on one or more caregiver devices to implement user interface and wakeability measurement, and portions executing on cloud processors to perform complex computations such as wakeability scoring, machine learning inference, and persistent logging.

The non-transitory computer-readable medium may be a component of a product of manufacture, such as a dedicated monitoring device, a smartphone, a smart speaker, or a wearable device. The instructions may be delivered to an end user via download over a network, via firmware update mechanisms, via cloud synchronization services, or pre-installed in the device memory at the time of manufacture, and such instructions may be updated or modified during the operational lifetime of the device.

### Illustrative Aspects

A method comprising: collecting sleep data from a first sleep tracker about a first person and a second sleep tracker about a second person; receiving a signal from a sensor; determining which of the first person or the second person to alert based on the sleep data and a criteria; and alerting the first person or the second person based on the determination.

The method of Aspect 1, wherein the criteria comprises which of the first person or the second person has had more sleep.

The method of Aspect 1, wherein the criteria comprises which of the first person or the second person has had more of either Rapid Eye Movement (REM) sleep, deep sleep, intermediate sleep, or light sleep.

The method of Aspect 1, wherein the criteria comprises which phase of the sleep cycle the first person and the second person are in at the time of the detection.

The method of Aspect 1, wherein the sensor comprises at least one of an optical sensor, an audio sensor, a thermo sensor, and a biometric sensor.

The method of Aspect 1, wherein the alerting comprises activating an alarm and the alarm comprises at least one of a haptic alert, an audio alert, or a visual alert.

The method of Aspect 1, wherein the criteria comprises which of the first person or the second person has more time until a first alarm or a second alarm corresponding to the first and the second persons.

The method of Aspect 1, wherein the criteria comprises which of the first person or the second person was previously alerted.

The method of Aspect 1, wherein the criteria comprises which of the first person or the second person has obtained a higher percentage of required sleep time.

The method of Aspect 1 further comprising at least two sensors, wherein the alerting comprises a different alert corresponding to a different signal or combination of signals from the at least two sensors.

The method of Aspect 1, wherein a magnitude of the alert increases with a duration of the detection.

The method of Aspect 1, wherein the criteria comprises which of the first person or the second person has completed the most sleep cycles.

The method of Aspect 1, wherein the criteria comprises alerting the first person during a period of time and alerting the second person during another time.

A system comprising: a processor coupled to a first sleep tracker, a second sleep tracker, and a sensor; the first sleep tracker gathers a first sleep data about a first person and transmits the first sleep data to the processor; the second sleep tracker gathers a second sleep data about a second person and transmits the second sleep data to the processor; the sensor monitors a subject and sends a signal to the processor when a change is detected; the processor determines whether to alert the first person or the second person based on the first sleep data, the second sleep data, and a criteria; and the processor alerts the first person or the second person based on the determination.

The system of claim 14 further comprises a first alert device and a second alert device corresponding to the first person and the second person, wherein the alert comprises a transmitting an alert signal to either the first alert device or the second alert device and the alert device receiving the alert signal activating an alarm.

The system of claim 15, wherein the first alert device is the first sleep tracker and the second alert device is the second sleep tracker.

The system of claim 15, wherein the alarm comprises at least one of a haptic alert, an audio alert, or a visual alert.

The system of claim 14, further comprises a second processor and a third processor, wherein the second processor receives the first sleep data from the first sleep tracker and the third processor receives the second sleep data from the second sleep tracker, and the second processor and the third processor transmit the first sleep data and the second sleep data to the processor.

The system of claim 14, wherein the sensor comprises at least one of an optical sensor, audio sensor, thermo sensor, heart rate monitor, and biometric sensor.

An apparatus comprising: at least one processor; and at least one memory comprising computer readable program code; the at least one memory and the computer readable program code configured to, with the at least one processor perform a process comprising: collecting sleep data from a first sleep tracker about a first person and a second sleep tracker about a second person; receiving a signal from a sensor; determining which of the first person or the second person to alert based on the sleep data and a criteria; and alerting the first person or the second person based on the determination.

### Exemplary Embodiments

The following paragraphs describe exemplary embodiments of the present disclosure. Each embodiment corresponds to a particular combination of features and limitations that may be implemented individually or in combination with other embodiments described herein. References to other embodiments within this section are for convenience only and do not limit the scope of any individual embodiment.

In certain embodiments, a system for coordinating selective caregiver alerting across a multi-device monitoring network comprises a hub device comprising a processor, a memory, an audio sensor, and a plurality of communication interfaces, the hub device positioned in proximity to a monitored subject. The system further comprises a first caregiver device and a second caregiver device, each configured to collect physiological data indicative of a sleep state of a respective caregiver and to transmit the physiological data to the hub device via a first communication protocol. The system further comprises a cloud processor communicatively coupled to the hub device via a network connection using a second communication protocol. The hub device is configured to detect an event associated with the monitored subject using the audio sensor, transmit event data and caregiver physiological data to the cloud processor to obtain a routing decision identifying a selected caregiver, and upon receiving the routing decision, transmit a targeted alert to a device associated with the selected caregiver. The hub device maintains a locally cached copy of caregiver state data received from the caregiver devices, and upon failure of the network connection to the cloud processor, the hub device executes a local routing decision using the locally cached caregiver state data to select a caregiver and transmit the targeted alert without the cloud processor.

In certain embodiments consistent with embodiment 1, the first communication protocol comprises a persistent bidirectional connection between each caregiver device and the hub device over a local network, and the second communication protocol comprises authenticated HTTP requests signed using a cryptographic key unique to the hub device.

In certain embodiments consistent with embodiment 2, each authenticated HTTP request includes a timestamp and a signature computed using a hash-based message authentication code over a concatenation of the timestamp and a request payload, using a secret key stored in non-volatile memory of the hub device.

In certain embodiments consistent with embodiment 1, the hub device further comprises a short-range radio interface configured to advertise presence data to wearable devices associated with the caregivers, and the short-range radio interface operates concurrently with the first communication protocol and the second communication protocol.

In certain embodiments consistent with embodiment 4, the short-range radio interface operates in a first mode during an initial provisioning phase to receive network credentials from a caregiver device, and transitions to a second mode during normal operation to transmit periodic heartbeat signals that maintain a background execution state of a companion application on the caregiver device.

In certain embodiments consistent with embodiment 1, the hub device executes a plurality of concurrent tasks with an assigned priority hierarchy, and an audio detection task executes at a higher priority than any network communication task, such that detection of events associated with the monitored subject is not delayed by network operations.

In certain embodiments consistent with embodiment 1, the locally cached caregiver state data comprises a wakeability score for each caregiver, the wakeability score previously computed by the cloud processor based on physiological data from the respective caregiver device and transmitted to the hub device, and the hub device applies the cached wakeability scores in the local routing decision when the cloud processor is unreachable.

In certain embodiments consistent with embodiment 1, the hub device is further configured to register up to a predetermined number of caregiver devices, assign a persistent role identifier to each registered caregiver device, store the registration in non-volatile memory, and restore the registration upon power loss or restart.

In certain embodiments consistent with embodiment 1, the cloud processor, upon receiving the event data from the hub device, returns one of: a target caregiver identifier directing the hub device to alert a specific caregiver, or a suppression signal directing the hub device to discard the event without alerting any caregiver.

In certain embodiments, a method for managing alert routing during a monitoring session in a caregiver alerting system comprises detecting, by a hub device, a first event associated with a monitored subject. The method further comprises determining a target caregiver from a plurality of caregivers based on a current alert routing mode, and transmitting a first alert to a device associated with the target caregiver. The method further comprises initiating a monitoring session having a defined duration, and locking the current alert routing mode and the target caregiver assignment for the duration of the monitoring session, such that changes to the alert routing mode received from caregiver devices during the monitoring session do not alter alert routing for subsequent events within the same monitoring session. Upon detecting a subsequent event within the monitoring session, the method routes a follow-up alert to the same target caregiver regardless of a current state of the alert routing mode. Upon expiration of the monitoring session, the method unlocks the alert routing mode and clears the target caregiver assignment.

In certain embodiments consistent with embodiment 10, upon receiving an acknowledgment from the target caregiver during the monitoring session, the duration of the monitoring session is extended by a predefined extension period.

In certain embodiments consistent with embodiment 10, the method further comprises maintaining a plurality of mutually exclusive suppression windows comprising a snooze window, a feeding window, and a response window, wherein detection of an event during any active suppression window causes the hub device to discard the event without transmitting an alert.

In certain embodiments consistent with embodiment 10, the alert routing mode is one of: a smart mode in which the target caregiver is selected based on physiological data, an alternating mode in which the target caregiver alternates between successive monitoring sessions, a schedule mode in which the target caregiver is determined based on a time-of-day schedule adjusted by a timezone offset received from a caregiver device, or a broadcast mode in which alerts are transmitted to all registered caregivers.

In certain embodiments consistent with embodiment 13, in the schedule mode, the hub device receives a timezone offset value from a caregiver device, computes a local time by applying the timezone offset to a coordinated universal time maintained by the hub device, and determines which caregiver is assigned to a current shift based on a comparison of the computed local time to a configurable shift boundary.

In certain embodiments consistent with embodiment 10, the method further comprises enforcing a minimum interval between successive alerts, wherein the hub device discards events detected within a predetermined time period following a most recent transmitted alert.

In certain embodiments consistent with embodiment 10, when the target caregiver device is not connected to the hub device at the time of alert transmission, the hub device transmits the alert to all connected caregiver devices as a broadcast fallback and additionally transmits the event to a cloud processor for delivery via a push notification service.

In certain embodiments, a method for determining a caregiver alert priority in a multi-caregiver monitoring system comprises receiving, from a wearable device associated with a caregiver, heart rate data collected during a sleep period. The method further comprises computing a heart rate variability metric from the heart rate data, and normalizing the heart rate variability metric against a baseline value to produce a normalized score, wherein the normalization comprises computing a deviation of the heart rate variability metric from the baseline value relative to a standard deviation associated with the baseline value. The method further comprises inverting the normalized score such that a higher heart rate variability, indicative of deeper sleep, produces a lower wakeability score and a lower heart rate variability, indicative of lighter sleep or wakefulness, produces a higher wakeability score. The wakeability score is used as an input to a routing decision that selects one of a plurality of caregivers to receive a targeted alert.

In certain embodiments consistent with embodiment 17, the baseline value is adaptively computed from historical heart rate variability data collected from the caregiver over a plurality of prior sleep sessions, and when insufficient historical data is available, the baseline value defaults to a population-derived value.

In certain embodiments consistent with embodiment 17, the method further comprises computing a motion score from accelerometer data received from the wearable device, the motion score representing a graded intensity of physical movement, and applying the motion score as a multiplicative factor to the wakeability score.

In certain embodiments consistent with embodiment 19, the motion score is computed using an accumulation model having an asymmetric response characteristic, wherein acceleration values exceeding a deviation threshold cause the motion score to increase at a first rate, and acceleration values below the deviation threshold cause the motion score to decrease at a second rate slower than the first rate.

In certain embodiments consistent with embodiment 17, the method further comprises computing an effective score for each caregiver by combining the wakeability score with a fairness penalty, wherein the fairness penalty is a non-linear function of a count of alerts previously assigned to the caregiver during a current monitoring period, and the magnitude of the fairness penalty increases at an accelerating rate as the alert count increases.

In certain embodiments consistent with embodiment 21, a time-decay adjustment is applied to the fairness penalty, wherein the magnitude of the penalty decreases over a defined decay period following each alert assignment, such that the penalty diminishes as time elapses since the caregiver last responded.

In certain embodiments consistent with embodiment 21, the method further comprises computing a deep sleep equity adjustment based on a disparity in cumulative deep sleep duration between the caregivers during the current monitoring period, and adding the deep sleep equity adjustment to the effective score.

In certain embodiments, a system for delivering caregiver alerts across parallel communication paths with deduplication comprises a hub device configured to detect an event associated with a monitored subject and to generate an alert message comprising a unique alert identifier. The system further comprises a cloud processor configured to receive the alert message from the hub device and to transmit the alert message to one or more caregiver devices via a plurality of independent delivery paths, the plurality of independent delivery paths comprising at least a first delivery path using a cloud messaging service directed to a mobile application on a caregiver smartphone and a second delivery path using a direct connection to a push notification service of a wearable device platform directed to a companion application on a caregiver wearable device. Each caregiver device receiving the alert message through any delivery path checks the unique alert identifier against previously received alert identifiers and suppresses duplicate presentations of the same alert. The system implements a timed escalation cascade such that if the alert is not acknowledged by the caregiver wearable device within a first timeout period, the system transmits a secondary alert to the caregiver smartphone as a fallback.

In certain embodiments consistent with embodiment 24, the first delivery path comprises a cloud messaging service that delivers the alert as a push notification to the mobile application, and the second delivery path comprises a direct HTTP/2 connection from the cloud processor to the push notification service of the wearable device platform using a JSON web token refreshed at a predetermined interval.

In certain embodiments consistent with embodiment 24, the cloud processor implements a retry mechanism for each delivery path comprising a plurality of transmission attempts with exponentially increasing delay intervals between attempts, and upon a permanent delivery failure on a delivery path, the cloud processor schedules asynchronous cleanup of an invalid device token associated with the failed path.

In certain embodiments consistent with embodiment 24, the timed escalation cascade further comprises transmitting the alert to all registered caregiver devices associated with the monitoring system if the alert is not acknowledged by either the caregiver wearable device or the caregiver smartphone within a second timeout period longer than the first timeout period.

In certain embodiments consistent with embodiment 24, the system further comprises a local delivery path from the hub device to the caregiver smartphone via a persistent bidirectional connection over a local network, wherein the local delivery path operates concurrently with the cloud-based delivery paths, and the unique alert identifier provides deduplication across all delivery paths.

In certain embodiments, a method for detecting a sustained audio event in a subject monitoring system comprises continuously sampling audio data from a microphone positioned in proximity to a monitored subject and computing an audio volume metric from the sampled audio data. The method further comprises maintaining an accumulation value that increases when the audio volume metric exceeds a configurable threshold and decreases when the audio volume metric is at or below the configurable threshold, wherein the accumulation value increases at a first rate and decreases at a second rate that is slower than the first rate, creating an asymmetric response characteristic. The method determines that a sustained audio event has occurred when the accumulation value reaches or exceeds a predetermined trigger level, and upon that determination, transmits an event signal to an alert routing module and resets the accumulation value.

In certain embodiments consistent with embodiment 29, the configurable threshold is dynamically adjustable during operation by a remote command received from a caregiver device, and the configurable threshold is computed from a user-selected sensitivity value using a mapping function that translates the sensitivity value to a digital audio level corresponding to characteristics of the microphone.

In certain embodiments consistent with embodiment 29, the audio volume metric is computed as a difference between a maximum sample value and a minimum sample value within a processing window of the sampled audio data, divided by a scaling factor.

In certain embodiments consistent with embodiment 29, the first rate is at least three times the second rate.

In certain embodiments consistent with embodiment 29, the audio sensor task executes at a higher processing priority than network communication tasks on the hub device, ensuring that audio sampling is not interrupted by network activity.

In certain embodiments, a method for maintaining continuous physiological monitoring of a caregiver during an extended sleep session using a wearable device and a companion mobile device comprises initiating, on the wearable device, a health monitoring session that collects heart rate data from a physiological sensor. The method further comprises maintaining a background execution state on the companion mobile device using a plurality of concurrent background persistence mechanisms, the plurality of concurrent background persistence mechanisms comprising at least two of: a silent audio session that prevents operating system suspension of the companion application, a background location session that maintains process execution priority, a state restoration protocol that enables the operating system to relaunch the companion application upon termination, and periodic background refresh tasks. The method further comprises periodically transmitting a heartbeat signal from the companion mobile device to the wearable device, and upon failure of the wearable device to receive the heartbeat signal within a predefined timeout, restarting the health monitoring session on the wearable device. The method further comprises monitoring a data freshness interval on the wearable device, and upon detecting that no heart rate data has been received from the physiological sensor within a staleness threshold, terminating and reinitializing the health monitoring session. The method further comprises persisting a monitoring state to non-volatile storage on the wearable device, such that upon application termination and relaunch by the operating system, the wearable device resumes monitoring without user intervention.

In certain embodiments consistent with embodiment 34, the health monitoring session on the wearable device comprises an exercise session interface provided by the operating system of the wearable device, and the method further comprises maintaining an extended runtime session on the wearable device that automatically restarts upon expiration.

In certain embodiments consistent with embodiment 34, on a cloud processor, the method further comprises monitoring a timestamp of most recent physiological data received from the wearable device, and upon determining that the timestamp exceeds a cloud-side staleness threshold, transmitting a wake signal to the companion mobile device to trigger reinitialization of the health monitoring session.

In certain embodiments consistent with embodiment 34, the persisted monitoring state comprises at least a session start time, a current alert routing mode, and a hub device identifier, and the monitoring state is subject to a maximum age limit beyond which it is discarded as stale.

In certain embodiments consistent with embodiment 34, the method further comprises maintaining a persistent wireless connection between the companion mobile device and a hub device using a state restoration protocol of the wireless communication stack, such that the companion mobile device automatically reconnects to the hub device upon application relaunch without user intervention.

In certain embodiments, a method for suppressing alerts in a caregiver monitoring system based on caregiver proximity comprises transmitting, by a hub device positioned in proximity to a monitored subject, a wireless advertisement signal. The method further comprises receiving, at a wearable device associated with a caregiver, the wireless advertisement signal and measuring a received signal strength value. The method further comprises computing an estimated distance between the wearable device and the hub device using a path loss model applied to the received signal strength value, the path loss model calibrated with a reference signal strength at a known reference distance. The method further comprises comparing the estimated distance to a configurable proximity threshold, and upon determining that the estimated distance is less than the configurable proximity threshold, transmitting a proximity status to the hub device or a cloud processor, causing the system to suppress alerts directed to the caregiver associated with the wearable device on the basis that the caregiver is already in proximity to the monitored subject.

In certain embodiments consistent with embodiment 39, the path loss model computes the estimated distance using a logarithmic relationship between received signal strength and distance, calibrated at a reference signal strength value measured at a predetermined reference distance.

In certain embodiments consistent with embodiment 39, proximity scanning is activated upon detection of an event associated with the monitored subject and is deactivated after a predetermined maximum scanning duration to conserve battery power on the wearable device.

In certain embodiments consistent with embodiment 39, the proximity status is periodically reported to the cloud processor at a defined reporting interval during an active monitoring event, and the cloud processor uses the proximity status as an input to a routing decision that selects a caregiver to receive an alert.

In certain embodiments, a method for performing firmware updates on a monitoring hub device in a caregiver alerting system comprises receiving, at the hub device, an indication that a firmware update is available. The method further comprises determining whether the hub device is in an idle state by evaluating whether any caregiver devices are connected to the hub device and whether an active monitoring session is in progress. Upon determining that the hub device is in the idle state, the method initiates the firmware update. Upon determining that the hub device is not in the idle state, the method defers the firmware update until the hub device enters the idle state, unless the firmware update is designated as mandatory, in which case the firmware update is initiated regardless of the current state.

In certain embodiments consistent with embodiment 43, the method further comprises determining whether the hub device is included in a current rollout group by computing a hash of a device identifier of the hub device and comparing the hash to a rollout percentage threshold, and only proceeding with the firmware update if the hash falls within the rollout percentage threshold.

In certain embodiments, an integrated caregiver alerting system comprises a hub device comprising a processor, a digital microphone, a wireless local area network interface, a short-range wireless radio, and a non-volatile memory, the hub device positioned in an environment of a monitored subject. The system further comprises a plurality of caregiver devices, each comprising a smartphone and a wearable device, each wearable device configured to collect physiological data from a respective caregiver and transmit the physiological data to the smartphone, and each smartphone configured to transmit the physiological data to the hub device via the wireless local area network interface. The system further comprises a cloud processor communicatively coupled to the hub device via a network, the cloud processor configured to receive physiological data from the caregiver devices, compute a wakeability score for each caregiver based on the physiological data, and determine a routing decision upon receiving event data from the hub device. The hub device is configured to continuously monitor audio from the digital microphone using an asymmetric accumulation algorithm to detect sustained audio events, upon detecting a sustained audio event transmit event data to the cloud processor and receive a routing decision, manage a monitoring session as a transactional unit by locking a target caregiver and routing mode for the duration of the session, transmit targeted alerts through a plurality of parallel delivery paths, and fall back to local routing using cached wakeability scores when the cloud processor is unreachable. The cloud processor is configured to transmit alerts through at least a first delivery path directed to the smartphone and a second delivery path directed to the wearable device, with each alert tagged with a unique identifier for deduplication across delivery paths. The wearable device is configured to maintain continuous physiological monitoring during an extended sleep session through a combination of health session watchdog logic, persistent state storage, and automatic session restart upon detection of data staleness.

In certain embodiments consistent with embodiment 45, the wearable device is further configured to perform proximity detection by receiving a wireless signal from the hub device, estimating a distance based on the received signal strength, and reporting a proximity status to the cloud processor, and the cloud processor suppresses alerts to a caregiver whose wearable device reports proximity to the hub device below a configurable distance threshold.

In certain embodiments consistent with embodiment 45, the cloud processor computes the wakeability score by normalizing a heart rate variability metric against an adaptive baseline, inverting the normalized value such that higher variability produces a lower wakeability score, and combining the inverted value with a motion-based multiplier and a heart rate adjustment to produce a composite wakeability score.

In certain embodiments consistent with embodiment 45, the cloud processor further computes an effective routing score for each caregiver by combining the wakeability score with a non-linear fairness penalty based on a count of prior alerts assigned to the caregiver, a time-decay adjustment that reduces the penalty as time elapses since the last alert, and a deep sleep equity adjustment based on cumulative sleep quality disparity between caregivers.

In certain embodiments, a non-transitory computer-readable medium stores instructions that, when executed by a processor of a hub device, cause the hub device to continuously sample audio data from a microphone and detect a sustained audio event using an accumulation model with an asymmetric response characteristic wherein the accumulation value increases at a first rate when audio volume exceeds a threshold and decreases at a second rate slower than the first rate when audio volume is at or below the threshold. The instructions further cause the hub device to, upon detecting the sustained audio event, transmit event data to a cloud processor via an authenticated request and receive a routing decision identifying a target caregiver, or upon failure to reach the cloud processor, execute a local routing decision using locally cached caregiver state data. The instructions further cause the hub device to initiate a monitoring session and lock the target caregiver assignment and routing mode for the duration of the session, routing follow-up alerts to the locked target caregiver. The instructions further cause the hub device to transmit the alert via a local network connection to a caregiver device and additionally cause the cloud processor to transmit the alert via at least one push notification delivery path, each alert tagged with a unique identifier for deduplication. The instructions further cause the hub device to manage a plurality of mutually exclusive suppression windows and discard events detected during any active suppression window.

In certain embodiments consistent with embodiment 49, the instructions further cause the hub device to accept firmware updates only when no caregiver devices are connected and no monitoring session is active, unless the update is designated as mandatory.

In certain embodiments consistent with embodiment 49, the instructions further cause the hub device to operate a short-range wireless radio in a provisioning mode to receive network credentials from a caregiver device during initial setup, and transition the short-range wireless radio to a heartbeat mode during normal operation to maintain background execution of a companion application on the caregiver device.

In certain embodiments, a system for coordinating selective caregiver alerting across a multi-device monitoring network comprises a coordination device comprising a processor, a memory, an audio sensor, and at least two communication interfaces operating on different communication protocols, the coordination device positioned in proximity to a monitored subject. The system further comprises a plurality of caregiver devices communicatively coupled to the coordination device via a first communication interface using a local communication protocol selected from the group consisting of: a persistent bidirectional connection protocol, a message queuing telemetry transport protocol, a constrained application protocol, and a remote procedure call protocol. The system further comprises a remote processor communicatively coupled to the coordination device via a second communication interface using an authenticated network protocol, wherein the authenticated network protocol employs a cryptographic credential stored in non-volatile memory of the coordination device to verify the identity of the coordination device. The coordination device is configured to detect an event associated with the monitored subject, transmit event data to the remote processor via the authenticated network protocol to obtain a routing decision, and transmit a targeted alert to a selected caregiver device via the local communication protocol. The coordination device maintains exclusive authority over routing decisions when the remote processor is unreachable, applying locally cached caregiver state data to select a caregiver independently of the remote processor.

In certain embodiments consistent with embodiment 52, the cryptographic credential comprises one of: a symmetric secret key used with a hash-based message authentication code, a JSON Web Token signed with a private key and refreshed at predetermined intervals, an OAuth 2.0 access token obtained through a client credentials grant, or a client-side TLS certificate used for mutual transport layer security authentication.

In certain embodiments consistent with embodiment 52, the coordination device further comprises a provisioning interface configured to receive initial device credentials from a caregiver device, the provisioning interface operating in one of: a short-range wireless proximity mode, a near-field communication mode in which credentials are transferred by physical contact between the caregiver device and the coordination device, or an optical code scanning mode in which credentials are encoded in a machine-readable visual code displayed on or affixed to the coordination device.

In certain embodiments consistent with embodiment 52, the coordination device comprises a general-purpose mobile computing device executing a monitoring application, the monitoring application implementing the routing decision logic, session state management, and cached caregiver state storage as software processes on the general-purpose mobile computing device, wherein the general-purpose mobile computing device is selected from the group consisting of: a smartphone, a tablet, a smart speaker, and an edge computing appliance.

In certain embodiments, a method for detecting a sustained audio event in a subject monitoring system comprises continuously sampling audio data from a microphone positioned in proximity to a monitored subject. For each of a plurality of successive time windows of the sampled audio data, the method computes an audio classification output indicating a likelihood that the time window contains an audio event of interest, the audio classification output produced by one of: a threshold comparison applied to a volume metric derived from the sampled audio data, a trained machine learning classifier applied to features extracted from the sampled audio data, or a spectral analysis applied to frequency-domain representations of the sampled audio data. The method further comprises maintaining a temporal persistence value that accumulates the audio classification outputs across successive time windows, the temporal persistence value increasing when the audio classification output indicates a likely event of interest and decreasing when the audio classification output indicates absence of an event of interest. The method determines that a sustained audio event has occurred when the temporal persistence value exceeds a detection threshold, the detection threshold requiring temporal persistence across a minimum number of successive time windows to distinguish sustained events from transient noise. Upon determining that the sustained audio event has occurred, the method transmits an event signal to an alert routing module.

In certain embodiments consistent with embodiment 56, the audio classification output is computed independently for each of a plurality of frequency bands of the sampled audio data, and determining that a sustained audio event has occurred requires that the temporal persistence value exceeds the detection threshold in at least two of the plurality of frequency bands concurrently.

In certain embodiments consistent with embodiment 56, the temporal persistence value increases at a variable rate determined by a spectral characteristic of the sampled audio data, the variable rate being higher when audio energy is concentrated in a frequency range associated with infant vocalization and lower when audio energy is distributed across a broader frequency range, thereby discriminating between infant distress sounds and ambient noise.

In certain embodiments consistent with embodiment 56, the volume metric is computed using one of: a difference between a maximum sample value and a minimum sample value within the time window divided by a scaling factor, a root-mean-square energy of sample values within the time window, or a logarithmic power spectral density of the sampled audio data within the time window.

In certain embodiments, a method for determining a caregiver alert priority in a multi-caregiver monitoring system comprises receiving, from a sensor device associated with a caregiver, physiological data collected during a rest period. The method further comprises computing at least one heart rate variability metric from the physiological data, the at least one heart rate variability metric selected from the group consisting of: a standard deviation of inter-beat intervals, a root-mean-square of successive inter-beat interval differences, a percentage of successive inter-beat intervals differing by more than a threshold duration, and a weighted combination of two or more of the foregoing metrics. The method further comprises normalizing the at least one heart rate variability metric against a personal baseline for the caregiver to produce a normalized score, the personal baseline derived from historical physiological data collected from the same caregiver over a plurality of prior rest periods. The method further comprises applying an inversion to the normalized score such that a physiological state indicative of deeper sleep produces a lower wakeability score and a physiological state indicative of lighter sleep or wakefulness produces a higher wakeability score. The wakeability score is used as an input to a routing decision that selects one of a plurality of caregivers to receive a targeted alert upon detection of a monitored event.

In certain embodiments consistent with embodiment 60, normalizing the at least one heart rate variability metric against the personal baseline comprises computing a percentile rank of the at least one heart rate variability metric within a distribution of historical heart rate variability values for the caregiver, the distribution maintained as a histogram or empirical cumulative distribution function updated with each new measurement.

In certain embodiments consistent with embodiment 60, the method further comprises computing a motion component from accelerometer data received from the sensor device, and combining the motion component with the wakeability score using one of: a multiplicative application in which the motion component scales the wakeability score, or an additive application in which the motion component is combined with the wakeability score using a weighted sum with configurable relative weights.

In certain embodiments consistent with embodiment 60, the physiological data comprises sleep stage classifications provided by a health monitoring application programming interface of an operating system of the sensor device, and the wakeability score is further adjusted based on a current sleep stage classification and an associated confidence value reported by the operating system.

In certain embodiments consistent with embodiment 60, the method further comprises computing a fairness penalty based on a count of alerts previously assigned to the caregiver, and applying a time-decay adjustment to the fairness penalty using one of: a linear decay over a defined period, an exponential decay with a configurable decay constant, or a piecewise decay in which recent alerts are weighted at full strength and older alerts are progressively deweighted.

In certain embodiments, a system for delivering caregiver alerts through heterogeneous notification channels comprises a monitoring device configured to detect an event associated with a monitored subject and generate an alert message comprising a unique alert identifier. The system further comprises a cloud processor configured to receive the alert message and transmit the alert message via a plurality of notification channels, the plurality of notification channels comprising at least two of: a push notification service directed to a mobile application, a push notification service directed to a wearable device application, a short message service directed to a telephone number associated with the caregiver, an email service directed to an email address associated with the caregiver, and a voice assistant service directed to a smart home device associated with the caregiver. Each notification channel delivers the alert message independently and concurrently with other notification channels. Each caregiver device or application receiving the alert message suppresses duplicate presentations of the same alert using the unique alert identifier or a timestamp-based deduplication mechanism. The system implements a timed escalation cascade in which additional notification channels are activated progressively if the alert is not acknowledged within successive timeout periods.

In certain embodiments consistent with embodiment 65, the voice assistant service delivers the alert by causing a smart home speaker device to audibly announce the alert, and the caregiver acknowledges the alert by speaking a voice command to the smart home speaker device, the voice command being relayed to the cloud processor as an acknowledgment signal.

In certain embodiments consistent with embodiment 65, the system further comprises a poll-based delivery mechanism in which the cloud processor assigns each alert a delivery ticket, and caregiver devices periodically query the cloud processor for pending delivery tickets, retrieve unacknowledged alerts, and present them to the caregiver, the poll-based delivery mechanism operating as a redundant delivery path alongside the push-based notification channels.

In certain embodiments consistent with embodiment 65, the unique alert identifier comprises one of: a universally unique identifier generated by the monitoring device at the time of event detection, a server-assigned timestamp with a device identifier tuple, or a combination of both a universally unique identifier and a timestamp, and the deduplication mechanism on each receiving device maintains a cache of previously received identifiers with a configurable retention period.

In certain embodiments, a method for adjusting alert routing in a caregiver monitoring system based on caregiver proximity to a monitored subject comprises determining an estimated distance between a device associated with a caregiver and a monitoring device positioned in proximity to the monitored subject, the estimated distance computed using at least one wireless ranging technique selected from the group consisting of: received signal strength indication with a path loss model, round-trip time measurement over a wireless network protocol, time-of-flight measurement using an ultra-wideband radio, and angle-of-arrival estimation using a directional antenna array. The method further comprises comparing the estimated distance to a proximity threshold, and upon determining that the estimated distance is less than the proximity threshold, modifying alert routing for the caregiver by one of: suppressing alerts directed to the caregiver, reducing a priority score of the caregiver in a routing decision, or re-routing the alert to a different caregiver determined to be farther from the monitored subject.

In certain embodiments consistent with embodiment 69, modifying alert routing comprises applying a tiered suppression policy based on the estimated distance, wherein a first distance range below a strict threshold causes full suppression of alerts to the caregiver, a second distance range between the strict threshold and a soft threshold causes suppression of low-intensity alerts while permitting delivery of high-intensity alerts, and a third distance range beyond the soft threshold results in no suppression.

In certain embodiments consistent with embodiment 69, the proximity threshold is contextually variable based on a detected location of the caregiver device, the detected location determined using one of: association with a specific wireless access point, identification of a specific wireless beacon, or a geofence boundary, and different locations are associated with different proximity thresholds stored in a configuration table on the monitoring device or a cloud processor.

In certain embodiments consistent with embodiment 69, the method further comprises detecting caregiver presence in the environment of the monitored subject using at least one environmental sensor on the monitoring device selected from the group consisting of: a passive infrared motion sensor, an acoustic presence detector that identifies human activity sounds, and a near-field communication interface that detects a tap event from a caregiver device, and the environmental sensor detection is used as supplementary proximity evidence in combination with the wireless ranging technique.

In certain embodiments, a method for managing alert routing during a monitoring session in a caregiver alerting system comprises detecting, by a monitoring device, a first event associated with a monitored subject. The method further comprises determining a target caregiver from a plurality of caregivers, initiating a monitoring session and constraining subsequent alert routing to the target caregiver for a duration of the monitoring session. The method further comprises adaptively adjusting the duration of the monitoring session based on caregiver interaction signals received during the session, the caregiver interaction signals comprising at least one of: an explicit acknowledgment that extends the session by a first extension period, a notification read event without acknowledgment that extends the session by a second extension period shorter than the first extension period, or an absence of any interaction that causes the session to expire at the current duration. Upon expiration of the monitoring session without acknowledgment, the method releases the constraint on alert routing and escalates the alert to at least one additional caregiver.

In certain embodiments consistent with embodiment 73, constraining subsequent alert routing comprises maintaining a priority queue of caregiver candidates, assigning the target caregiver to the head of the priority queue, and preventing routing to any caregiver other than the head of the priority queue for the duration of the monitoring session, and upon session expiration without acknowledgment, advancing the priority queue to select the next caregiver candidate.

In certain embodiments consistent with embodiment 73, determining the target caregiver comprises applying a predictive model trained on historical alert response data, the predictive model receiving as inputs at least a current time of day and physiological state indicators for each caregiver, and outputting a predicted response probability for each caregiver, and the caregiver with the highest predicted response probability is selected as the target caregiver.

In certain embodiments consistent with embodiment 73, upon escalating the alert, the method transmits the alert to the at least one additional caregiver using a sequential escalation protocol in which caregivers are contacted in a ranked order with a configurable delay between each successive transmission, the configurable delay adapted based on historical response latency of each caregiver.

In certain embodiments, a method for performing firmware updates on a monitoring device in a caregiver alerting system while maintaining monitoring continuity comprises receiving, at the monitoring device, firmware update data. The method further comprises writing the firmware update data to an inactive storage partition of the monitoring device while the monitoring device continues to operate from an active storage partition, such that monitoring and alert routing functions remain operational during the write operation. Upon completion of writing the firmware update data, the method schedules a partition switch to activate the inactive storage partition upon a next restart of the monitoring device. Upon restart, the method executes a validation sequence on the newly activated partition, the validation sequence comprising at least verification that an audio detection task, an alert routing task, and a communication task initialize successfully. Upon failure of the validation sequence, the method automatically reverts to the previously active partition without user intervention, and logs the failure for remote diagnostic retrieval.

In certain embodiments consistent with embodiment 77, the firmware update data comprises an update to a single module of a plurality of independently versioned firmware modules on the monitoring device, the plurality of independently versioned firmware modules comprising at least an audio detection module, a communication module, and an alert routing module, and updating the single module does not require rewriting firmware data for the remaining modules.

In certain embodiments consistent with embodiment 77, the method further comprises monitoring for events associated with the monitored subject during the firmware update write operation, and upon detecting an event, immediately suspending the write operation, processing the event through the active partition's alert routing logic, and resuming the write operation only after the event has been resolved.

In certain embodiments, a method for maintaining continuous physiological monitoring of a caregiver during an extended rest period using a wearable device and a companion device comprises initiating, on the wearable device, a health monitoring session that collects physiological data from a sensor. The method further comprises maintaining background execution of a monitoring application on the companion device using at least one platform-provided persistence mechanism selected from the group consisting of: a foreground service with a persistent notification, a silent media playback session, a background location monitoring session, a periodic background task registered with an operating system scheduler, and a state restoration callback registered with the operating system. The method further comprises monitoring connectivity between the wearable device and the companion device, and upon detecting a connectivity interruption exceeding a staleness threshold, automatically reinitializing the health monitoring session on the wearable device without user intervention. The method further comprises persisting a monitoring state to non-volatile storage on at least one of the wearable device and the companion device, the monitoring state including at least a session identifier and a timestamp, such that upon application termination and relaunch by the operating system, monitoring resumes from the persisted state. The method further comprises receiving, from a cloud processor, a liveness signal when the cloud processor determines that physiological data from the caregiver has not been received within a cloud-side staleness threshold, the liveness signal triggering reinitialization of the health monitoring session.

In certain embodiments consistent with embodiment 80, the health monitoring session on the wearable device interfaces with a native health monitoring application programming interface provided by the operating system of the wearable device, the native health monitoring application programming interface providing continuous access to physiological sensor data including heart rate, heart rate variability, and motion data, and the monitoring application registers for event-driven callbacks from the native health monitoring application programming interface to receive updated physiological data without continuous foreground execution.

In certain embodiments consistent with embodiment 80, upon detecting that one or more components of the monitoring system are degraded or unavailable, the system transitions to a reduced-capability monitoring mode in which: if physiological data from the wearable device is unavailable, the system routes alerts based on a most recent cached wakeability score with a staleness indicator; if the companion device connectivity is intermittent, the system increases a polling frequency for alert delivery; and if the cloud processor is unreachable, the system operates in a local-only mode using cached routing state on a hub device.

In certain embodiments consistent with embodiment 80, the wearable device comprises a cellular-connected wearable device that transmits physiological data directly to the cloud processor via a cellular network connection without requiring the companion device as an intermediary, and the companion device serves as a redundant data path and local alert presentation device.

In certain embodiments, a non-transitory computer-readable medium stores instructions that, when executed by a processor of a monitoring device, cause the monitoring device to continuously sample audio data from a microphone and, for each of a plurality of successive time windows, compute an audio classification output using one of a threshold-based volume comparison, a trained machine learning classifier, or a spectral analysis, and maintain a temporal persistence value that accumulates the audio classification outputs to detect sustained audio events while rejecting transient noise. The instructions further cause the monitoring device to, upon detecting a sustained audio event, transmit event data to a remote processor via an authenticated communication channel using a cryptographic credential selected from the group consisting of a hash-based message authentication code, a JSON Web Token, an OAuth 2.0 token, and a mutual TLS certificate, and receive a routing decision, or upon failure to reach the remote processor, execute a local routing decision using cached caregiver state. The instructions further cause the monitoring device to initiate a monitoring session and adaptively manage the session duration based on caregiver interaction signals, constraining alert routing to a target caregiver for the duration of the session. The instructions further cause the monitoring device to deliver alerts via a plurality of heterogeneous notification channels comprising at least two of: push notifications, short message service, email, voice assistant announcements, and local network connections, with deduplication applied across all channels. The instructions further cause the monitoring device to adjust alert routing based on caregiver proximity determined using at least one wireless ranging technique, modifying routing by suppressing alerts, reducing caregiver priority, or re-routing to a more distant caregiver.

In certain embodiments consistent with embodiment 84, the instructions further cause the monitoring device to write firmware update data to an inactive storage partition while continuing to operate from an active storage partition, schedule a partition switch upon restart, execute a validation sequence on the new partition, and automatically revert to the previous partition if validation fails.

In certain embodiments consistent with embodiment 84, the instructions further cause the monitoring device to operate a short-range wireless interface in a provisioning mode using one of a proximity-based pairing protocol, a near-field communication protocol, or an optical code scanning protocol to receive device credentials, and transition the short-range wireless interface to a heartbeat mode during normal operation.

While the foregoing detailed description has described certain embodiments of the present disclosure, it is to be understood that the above description is illustrative only and not limiting of the disclosed invention. It will be appreciated that specific embodiments have been described herein for purposes of illustration, but that various modifications may be made without deviating from the spirit and scope of the invention. In particular, the selection of specific protocols, algorithms, metrics, data structures, and hardware platforms described herein are examples and should not be construed as limitations. Accordingly, the invention is not limited except as by the appended claims.

What is claimed:

1. An integrated monitoring system comprising:
a monitoring device comprising a processor and a microphone, the monitoring device positioned in an environment of a monitored subject;
a plurality of caregiver devices, each associated with a respective caregiver, wherein at least one caregiver device comprises
a wearable device configured to collect physiological data from the respective caregiver during a sleep period; and
a routing processor communicatively coupled to the monitoring device and to the plurality of caregiver devices, the routing processor configured to:
receive physiological data from the at least one wearable device,
compute a sleep-state metric for each caregiver based on the received physiological data,
upon receiving event data indicating detection of an audio event by the monitoring device, select a target caregiver from the plurality of caregivers based at least in part on a routing mode, wherein the routing mode is selected by the caregiver from a plurality of routing mode options,
cause a targeted alert to be transmitted to a caregiver device associated with the selected target caregiver, and
lock the target caregiver assignment for a duration of a monitoring session such that subsequent events detected during the monitoring session are routed to the same target caregiver without re-evaluating which caregiver to target.

2. The system of claim 1, wherein one of the routing modes is based at least in part on sleep state metrics of the caregiver wherein the sleep-state metric comprises a wakeability score computed from a heart rate variability measurement, wherein a higher heart rate variability indicative of deeper sleep produces a lower wakeability score.

3. The system of claim 2, wherein the wakeability score is further adjusted by a motion-based factor derived from accelerometer data collected by the wearable device, such that detected physical movement increases the wakeability score.

4. The system of claim 2, wherein the routing processor computes an effective routing score for each caregiver by combining the sleep-state metric with a fairness adjustment based on a count of prior alerts assigned to the caregiver during a current monitoring period, such that a caregiver who has received more prior alerts receives a lower effective routing score.

5. The system of claim 2, wherein the monitoring device stores locally cached sleep-state metrics previously received from the routing processor, and wherein, when the routing processor is unreachable, the monitoring device selects the target caregiver using the locally cached sleep-state metrics.

6. The system of claim 1, wherein the monitoring device detects the audio event by maintaining an accumulation value that increases at a first rate when an audio volume metric exceeds a configurable threshold and decreases at a second rate lower than the first rate when the audio volume metric does not exceed the configurable threshold, and wherein the monitoring device determines that the audio event has occurred when the accumulation value exceeds a trigger level.

7. A method for selectively routing an alert in a multi-caregiver monitoring system, the method comprising:
receiving physiological data from a wearable device worn by each of a plurality of caregivers, the physiological data collected during a sleep period;
computing, for each caregiver, a sleep-state metric based on the physiological data, the sleep-state metric representing a relative likelihood that the caregiver is in a lighter stage of sleep;
upon detecting an event associated with a monitored subject, selecting a target caregiver from the plurality of caregivers based at least in part on the computed sleep-state metrics; and
transmitting a targeted alert to a device associated with the selected target caregiver while withholding the alert from devices associated with non-selected caregivers.

8. The method of claim 7, wherein computing the sleep-state metric comprises deriving a heart rate variability value from heart rate data received from the wearable device, normalizing the heart rate variability value against a baseline, and inverting the normalized value such that higher heart rate variability produces a lower sleep-state metric value indicative of deeper sleep.

9. The method of claim 8, wherein the baseline is adaptively computed from heart rate variability data collected from the caregiver over a plurality of prior sleep sessions, and wherein when insufficient historical data is available, the baseline defaults to a population-derived value.

10. The method of claim 7, further comprising computing an effective score for the target caregiver selection by combining the sleep-state metric with at least one of: a non-linear fairness penalty that increases at an accelerating rate as a count of prior alerts assigned to the caregiver increases, a time-decaying adjustment that reduces a penalty magnitude as time elapses since a most recent alert assignment, or a deep sleep equity adjustment based on cumulative sleep quality disparity between caregivers.

11. The method of claim 7, further comprising, upon selecting the target caregiver, locking the target caregiver assignment for a duration of a monitoring session such that subsequent events detected during the monitoring session are routed to the same target caregiver without re-evaluating the sleep-state metrics.

12. A method for detecting sustained audio events in an environment of a monitored subject, the method comprising:
sampling audio data from a microphone positioned in the environment of the monitored subject;
computing an audio volume metric from the sampled audio data;
maintaining an accumulation value, wherein the accumulation value is increased at a first rate when the audio volume metric exceeds a configurable threshold and is decreased at a second rate when the audio volume metric does not exceed the configurable threshold, the first rate being greater than the second rate;
determining that a sustained audio event has occurred when the accumulation value reaches a predetermined trigger level; and
upon determining that the sustained audio event has occurred, transmitting event data to initiate an alert to at least one caregiver device.

13. The method of claim 12, wherein the configurable threshold is dynamically adjustable based on a sensitivity setting received from a caregiver device, and wherein the sensitivity setting is mapped to the configurable threshold by a mapping function that produces a lower threshold for a higher sensitivity setting.

14. The method of claim 12, further comprising, upon transmitting the event data, resetting the accumulation value to zero in preparation for detection of a subsequent audio event.

15. The method of claim 12, wherein the first rate and the second rate have a ratio of at least three to one, and wherein the ratio causes the accumulation value to decay gradually during brief pauses in the audio pattern, thereby enabling detection of sustained events with intermittent characteristics.

16. A system for maintaining continuous physiological monitoring of a caregiver during an sleep session, the system comprising:
a wearable device configured to collect physiological data from the caregiver via a physiological sensor and to transmit the physiological data to a companion mobile device; and
the companion mobile device configured to:
maintain a background execution state using at least one background persistence mechanism that prevents an operating system of the companion mobile device from suspending a monitoring application,
periodically transmit a keep-alive signal to the wearable device, and
upon detecting an interruption in the physiological data from the wearable device, cause the wearable device to reinitialize the collection of physiological data.

17. The system of claim 16, wherein the at least one background persistence mechanism comprises two or more of: a silent audio session that prevents operating system suspension, a background location session that maintains process execution priority, a state restoration protocol that enables the operating system to relaunch the monitoring application upon termination, or periodic background refresh tasks.

18. The system of claim 16, wherein the wearable device monitors a data freshness interval and, upon detecting that no physiological data has been received from the physiological sensor within a staleness threshold, terminates and reinitializes a health monitoring session on the wearable device.

19. The system of claim 16, wherein the wearable device persists a monitoring state to non-volatile storage, the monitoring state comprising at least a session identifier and a monitoring device identifier, such that upon application termination and relaunch by the operating system of the wearable device, the wearable device resumes monitoring using the persisted monitoring state without user intervention.

20. The system of claim 16, further comprising a cloud processor configured to monitor a timestamp of most recent physiological data received from the wearable device and, upon determining that the timestamp exceeds a staleness threshold, transmit a wake signal to the companion mobile device to trigger reinitialization of the health monitoring session on the wearable device.
